(19) United States
(12) Patent Application Publication
(10) Pub. No.: US 2026/0225271 A1
(43) Pub. Date: Aug. 6, 2026

(54) SELF-CLEANING ROTARY SHAVER SYSTEM

(71) Applicant: Brio Product Group LLC, Davisburg, MI (US)

(72) Inventors: Eric John Steckling, Ann Arbor, MI (US); Richard Oman Evans, South Jordan, UT (US)

(21) Appl. No.: 19/043,075

(22) Filed: Jan. 31, 2025

(51) Int. Cl. B26B 19/38; B26B 19/14; B26B 19/28

(52) U.S. Cl. CPC B26B 19/3833; B26B 19/14; B26B 19/28; B26B 19/384

(57) ABSTRACT

A shaving system includes a shaver head including a shaver blade, the shaver blade being aligned with an opening formed in a foil assembly so as to enable the shaver blade to clip hair extending through the opening, a propeller including propeller blades, the propeller being attached to an upper side of the shaver blade, and a containment cylinder including a discharge port that opens outwardly from a gear housing so as to fluidically connect an interior of the containment cylinder and an environment outside of the gear housing. In response to the shaver head being at least partially submerged in fluid, rotation of the propeller draws the fluid upwardly through the opening of the foil assembly, into the containment cylinder, and outwardly through the discharge port such that the fluid flows over the shaver blade and removes hair clippings therefrom.

### TECHNICAL FIELD

The present disclosure relates generally to grooming devices having a cleaning mechanism, more particularly, to systems and methods for cleaning and maintaining such devices.

### BACKGROUND

Baldness is a common condition experienced by men, often beginning in their early twenties. A popular solution for this is shaving the head entirely, a choice that is fashionable but can also be labor-intensive. Traditional manual shaving with a razor delivers a close, smooth shave but requires multiple steps, including water, shaving cream, and careful use of a mirror, making it time-consuming and effortful.

Electric trimmers provide a faster alternative, though they fail to achieve the same level of smoothness. Rotary electric shavers deliver a balance of convenience and closeness. However, these devices require frequent cleaning of the shaver head to remove accumulated hair trimmings, which undermines their ease of use. The manual disassembly and cleaning processes detracts from the overall efficiency that electric shavers promise.

The present disclosure is directed to a self-cleaning rotary shaving system configured to reduce manual maintenance while ensuring effective hair removal. By automating the shaver head of the shaving system, the shaving system disclosed enhances user convenience and satisfaction.

### SUMMARY

In a first aspect, the present disclosure is directed to a shaver head including a gear housing cover, a gear housing positioned on an upper side of the gear housing cover, a foil assembly arranged on a lower side of the gear housing cover opposite the upper side, at least one shaver blade including a plurality of cutting blades arranged in an annular configuration, the at least one shaver blade being positioned on a post located on the gear housing cover and configured to rotate with the post, the at least one shaver blade being aligned with an opening formed in the foil assembly so as to enable the at least one shaver blade to clip hair extending through the opening, a propeller including a plurality of the propeller blades, the propeller being attached to an upper side of the at least one shaver blade, and a containment cylinder including a proximal end attached to the gear housing cover and surrounding the post and the propeller, the containment cylinder further including at least one discharge port that opens outwardly from the gear housing so as to fluidically connect an interior of the containment cylinder and an environment outside of the gear housing. In response to the shaver head being at least partially submerged in a fluid, rotation of the propeller in a first rotational direction draws the fluid upwardly through the opening of the foil assembly, into the containment cylinder, and outwardly through the at least one discharge port such that the fluid flows over the at least one shaver blade and removes hair clippings therefrom.

In some embodiments of the first aspect, the shaving system may further comprise a cleaning assembly including a cleaning and drying container having a grated tray bottom, the cleaning and drying container configured to be positioned in a cleaning base container.

In some embodiments of the first aspect, the grated tray bottom of the cleaning and drying container may be positioned in the cleaning base container at minimal height from a bottom of the cleaning base container, wherein the cleaning base container may be configured to receive the fluid therein and is configured to be filled with the fluid such that at least some of the fluid is above the grated tray bottom, and wherein a lower surface of the foil assembly of the shaver head may be configured to rest on the grated tray bottom such that the fluid may be drawn up by the propeller of the shaver head in response to the rotation of the propeller in the first rotational direction.

In some embodiments of the first aspect, the cleaning and drying container may further include a U-shaped channel extending around a perimeter of the cleaning and drying container that is configured to receive an upper perimeter edge of the cleaning base container such that the cleaning and drying container is supported within the cleaning base container by the upper perimeter edge.

In some embodiments of the first aspect, the cleaning and drying container may further include a drying tray pivotably coupled to a side wall of the cleaning and drying container, and wherein the dying tray may be configured to be pivoted between a non-use position and a use position in which the drying tray may be disposed at a first height above the grated tray bottom.

In some embodiments of the first aspect, the shaver head may be configured to be attached to a handle, wherein the handle may be operable to selectively operate the shaver head in a cleaning mode and in a shaving mode.

In some embodiments of the first aspect, when the shaving system is operating in the cleaning mode, the plurality of propeller blades of the propeller may rotate in the first rotational direction so as to draw the fluid upwardly through the opening of the foil assembly, into the containment cylinder, and outwardly through the at least one discharge port.

In some embodiments of the first aspect, when the shaving head is operating in the shaving mode, the plurality of propeller blades of the propeller may be configured to rotate in a second rotational direction opposite the first rotational direction such that the at least one shaver blade is configured to clip hair extending through the opening of the foil assembly.

In some embodiments of the first aspect, the shaving system may further comprise a lower housing arranged between the gear housing cover and the foil assembly and attached to the gear housing cover, the lower housing including at least one opening aligned with the propeller and the at least one shaver blade, the at least one opening including two pivot posts arranged on an inner surface of the at least one opening and spaced apart from each other, wherein the foil assembly may further include at least one foil base having an opening that defines the opening of the foil assembly, the foil base further including two pivot tabs extending upwardly from a base portion of the foil base, and wherein the two pivot tabs may each include a pivot hole that receives one of the two pivot posts of the lower housing so as to enable pivoting of the foil base relative to the lower housing.

In a second aspect, the present disclosure is directed to a shaver head comprising a gear housing assembly including at least one discharge opening, a foil assembly arranged under the gear housing assembly and including at least one opening, at least one shaver blade rotatably coupled to the gear housing assembly, and a propeller including a plurality of the propeller blades, the propeller being attached to an upper side of the at least one shaver blade, the at least one shaver blade and the propeller being aligned with the at least one opening of the foil assembly. The rotation of the propeller in a first rotational direction is configured to draw a fluid located outside of the shaver head upwardly through the at least one opening of the foil assembly, over the at least one shaver blade and the propeller, and outwardly through the at least one discharge opening of the gear housing cover.

In some embodiments of the second aspect, the shaver head may further comprise a gear housing cover coupled to a lower side of a gear housing of the gear housing assembly, the gear housing including the at least one discharge opening, the propeller being rotatably coupled to the gear housing cover, and at least one containment cylinder including a proximal end attached to the gear housing cover and surrounding the propeller.

In some embodiments of the second aspect, the shaver head may further comprise a lower housing arranged between the gear housing cover and the foil assembly and attached to the gear housing cover, the lower housing including at least one opening aligned with the propeller and the at least one shaver blade, the at least one opening including two pivot posts arranged on an inner surface of the at least one opening and spaced apart from each other, wherein the foil assembly may further include a foil base having an opening that defines the opening of the foil assembly, the foil base further including two pivot tabs extending upwardly from a base portion of the foil base, and wherein the two pivot tabs each include a pivot hole that receives one of the two pivot posts of the lower housing so as to enable pivoting of the foil base relative to the lower housing.

In some embodiments of the second aspect, the at least one containment cylinder may further include at least one discharge port having a terminal end arranged on the at least one discharge opening of the gear housing so as to fluidically connect an interior of the at least one containment cylinder and an environment outside of the gear housing, wherein the at least one shaver blade may be aligned with the at least one opening formed in the foil assembly so as to enable the at least one shaver blade to clip hair extending through the at least one opening, and wherein the rotation of the propeller in the first rotational direction draws the fluid upwardly through the at least one opening of the foil assembly, into the containment cylinder, and outwardly through the at least one discharge port such that the fluid flows over the at least one shaver blade and removes hair clippings therefrom and discharges the hair clippings via the at least one discharge port and the at least one discharge opening.

In some embodiments of the second aspect, the shaver head may be configured to be cleaned in a cleaning assembly comprising a cleaning and drying container having a grated tray bottom, the cleaning and drying container may be configured to be positioned in a cleaning base container at a minimal height from a bottom of the cleaning base container, and wherein the fluid is arranged in the cleaning base container such that the shaver head can be at least partially submerged in the fluid so as to allow the rotation of the propeller to draw the fluid upwardly and into the shaver head.

In some embodiments of the second aspect, the shaver head may be configured to be attached to a handle, wherein the handle is operable to selectively operate the shaving head in a cleaning mode and in a shaving mode.

In some embodiments of the second aspect, when the shaving head is operating in the shaving mode, the plurality of propeller blades of the propeller may be configured to rotate in a second rotational direction opposite the first rotational direction such that the at least one shaver blade is configured to clip hair extending through the at least one opening of the foil assembly.

In a third aspect, the present disclosure is directed to a method of cleaning a shaver head, comprising placing a shaver head in a cleaning assembly comprising a cleaning and drying container having a grated tray bottom, the cleaning and drying container being positioned in a cleaning base container at a minimal height from a bottom of the cleaning base container, wherein the cleaning base container includes a fluid therein, wherein the shaver head includes a gear housing having a shaver blade rotatably arranged therein and a propeller fixedly attached to the shaver blade, the shaver head further including a foil assembly coupled to the gear housing and having an opening aligned with the propeller, and operating the shaver head in a cleaning mode in which the propeller rotates in a first rotational direction such that the propeller draws the fluid arranged in the cleaning base container upwardly through the opening of the foil assembly.

In some embodiments of the third aspect, the shaver head may be configured to operate in a shaving mode in which the propeller is rotated in a second direction opposite to the first direction, and wherein the shaver blade is aligned with the opening of the foil assembly so as to enable the at shaver blade to clip hair extending through the opening.

In some embodiments of the third aspect, the shaver head may further comprise at least one containment cylinder including a proximal end attached to the gear housing and surrounding the propeller and the at least one shaver blade.

In some embodiments of the third aspect, wherein the containment cylinder may further include at least one discharge port that opens outwardly from the gear housing so as to fluidically connect an interior of the at least one containment cylinder and an environment outside of the gear housing, and wherein the rotation of the propeller in the first rotational direction draws the fluid upwardly through the opening of the foil assembly, into the at least one containment cylinder, and outwardly through the at least one discharge port such that the fluid flows over the at least one shaver blade and removes hair clippings therefrom.

### BRIEF DESCRIPTION OF THE DRAWINGS

The detailed description particularly refers to the following figures, in which:

FIG. 1 is a perspective view of a first aspect of the present disclosure showing a shaver head showing a gear connection positioned in a gear housing that is attached to a gear housing cover arranged within a cavity of the gear housing, a lower housing, and a central brace arranged between and coupled to the lower housing and the gear housing, and showing a discharge opening formed in the gear housing;

FIG. 2 is a perspective view of the gear connection of FIG. 1, the gear connection being configured to be positioned on an upper side of the gear housing;

FIG. 3 is a perspective view of the gear housing of FIG. 1, showing that the gear housing includes a plurality of concave portions configured to receive the gear housing cover therein;

FIG. 4A is a top view of the gear housing cover of FIG. 1, the gear housing cover being configured to be attached to a lower side of the gear housing and within the concave portions of the gear housing;

FIG. 4B is a bottom view of the gear housing cover of FIG. 1, showing a plurality of posts each configured to hold a shaver blade of a plurality of shaver blades in the shaver head, each post being configured to rotate the corresponding shaver blade arranged thereon as well as a propeller attached to the shaver blade;

FIG. 5 is a perspective view of the lower housing of FIG. 1, showing a plurality of openings aligned with the position of the shaver blades, and showing that each opening includes two pivot posts to which a foil base of a foil assembly of the shaver head is pivotably coupled;

FIG. 6 is a perspective view of a shaver blade of the shaver head of FIG. 1, showing that the shaver blade includes a plurality of cutting blades arranged in an annular configuration;

FIG. 7 is a perspective view of a propeller of the shaver head of FIG. 1, showing that the propeller includes a plurality of propeller blades arranged in an annular configuration, the propeller being configured to be fixedly attached to the shaver blade of FIG. 6;

FIG. 8 is a perspective view of the propeller of FIG. 7 attached to an upper side of the shaver blade of FIG. 6;

FIG. 9 is a perspective view of the gear housing, the gear housing cover, and one propeller and shaver blade assembly of the shaver head of FIG. 1, showing that the shaver head further includes a plurality of containment cylinders attached to the gear housing cover and surrounding the posts of the gear housing cover of FIG. 4B;

FIG. 10 is a perspective view of the containment cylinder of FIG. 9, showing that the containment cylinder includes a discharge port extending radially outwardly from a main annular wall of the containment cylinder;

FIG. 11 is a perspective view of a foil of the foil assembly of the shaver head of FIG. 1, the foil being configured to be arranged in the foil base of FIG. 12, the foil base being pivotably coupled to the pivot posts of an opening of the lower housing for pivotal movement relative thereto, and showing that the foil base and the foil can be positioned in a corresponding opening of the lower housing of FIGS. 13A and 13B;

FIG. 12 is a perspective view of a foil base configured to hold the foil of FIG. 11, showing that the foil base includes tabs having pivot holes through which the pivot posts of the lower housing extend for pivotal movement of the foil base.

FIG. 13A is an exploded view of the shaver head of FIG. 1 from a top perspective;

FIG. 13B is an exploded view of the shaver head of FIG. 1 from a bottom perspective;

FIG. 14A is a top view of the shaver head comprising the gear connection positioned on the upper surface of the gear housing, and further attached to the upper surface gear housing cover;

FIG. 14B is a side view of the shaver head of FIG. 14A without the shaver blades;

FIG. 14C is a bottom view of the shaver head of FIG. 14A without the shaver blades;

FIG. 14D is a side view of the shaver head of FIG. 14A with the shaver heads and propellers arranged within the containment cylinders of the gear housing;

FIG. 14E is a bottom view of the shaver head of FIG. 14A with the shaver heads and propellers arranged within the containment cylinders of the gear housing;

FIG. 15A is a side view of the shaver head comprising the gear connection positioned on the upper surface of the gear housing, the lower housing, and the foil assembly;

FIG. 15B is a bottom view of the shaver head of FIG. 15A;

FIG. 16 is perspective view of a cleaning assembly including a cleaning and drying container configured to be positioned in a cleaning base container;

FIG. 17A is an illustration of a shaving system comprising the shaver head of FIG. 1 attached to a handle and operating in a cleaning mode when placed on a grated tray bottom of the cleaning and drying container; and

FIG. 17B is an illustration of a shaving system comprising the shaver head of FIG. 1 attached to a handle and operating in a drying mode when placed on a drying tray of the cleaning and drying container.

### DETAILED DESCRIPTION OF THE DRAWINGS

While the concepts of the present disclosure are susceptible to various modifications and alternative forms, specific illustrative embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

Terms representing anatomical references, such as anterior, posterior, medial, lateral, superior, inferior, upper, lower, top, bottom, etcetera, may be used throughout the specification in reference to the devices described herein as well. Use of such anatomical reference terms in the written description and claims is intended to be consistent with their well-understood meanings unless noted otherwise.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

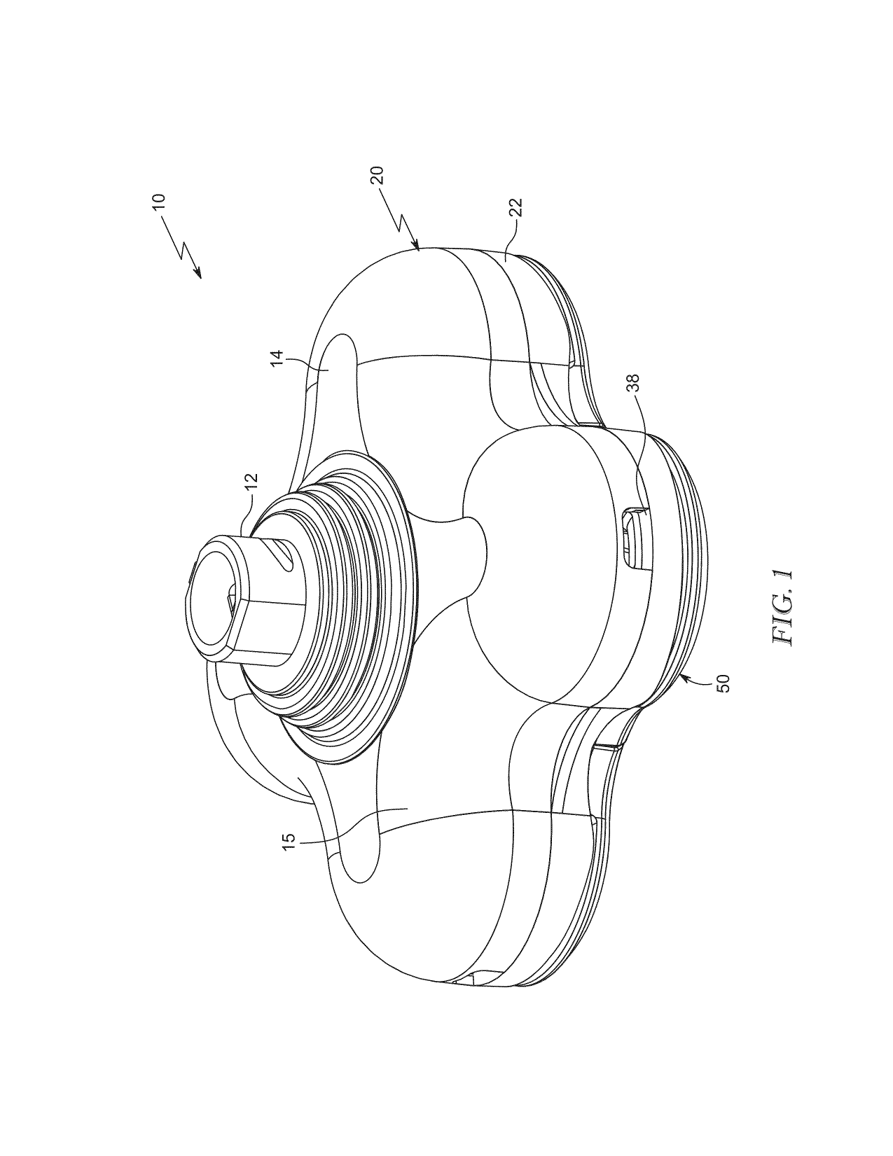

A first embodiment of a self-cleaning rotary shaving system 100 comprising a shaver head 10 and a cleaning assembly 60 is shown in FIGS. 1-17B. In one exemplary embodiment, the shaver head 10 includes a gear housing assembly 20, a plurality of shaver blades 40 that are configured to be positioned in the gear housing assembly 20, and a foil assembly 50. The shaving system 100 is configured to operate in one of three different modes. Specifically, the shaver head 10 may operate in a shaving mode when used to cut hair by a user, in a cleaning mode when used to clean the hair trimmings from within components of the shaver head 10 after shaving, and in a drying mode after being operated in the cleaning mode. A button 82 on a handle 80 attachable to the shaver head 10 is operable to change operating modes of the shaver head 10 between the cleaning, shaving, or drying modes.

Referring now to FIGS. 1-3, in an illustrative embodiment, the gear housing assembly 20 includes a gear connection 12 positioned on an upper side 15 of a gear housing 14 that is attached to a gear housing cover 16, and a lower housing 22. As will be described in greater detail below, the lower housing 22 is coupled to a lower side 17B, opposite to the upper side 17A, of the gear housing cover 16.

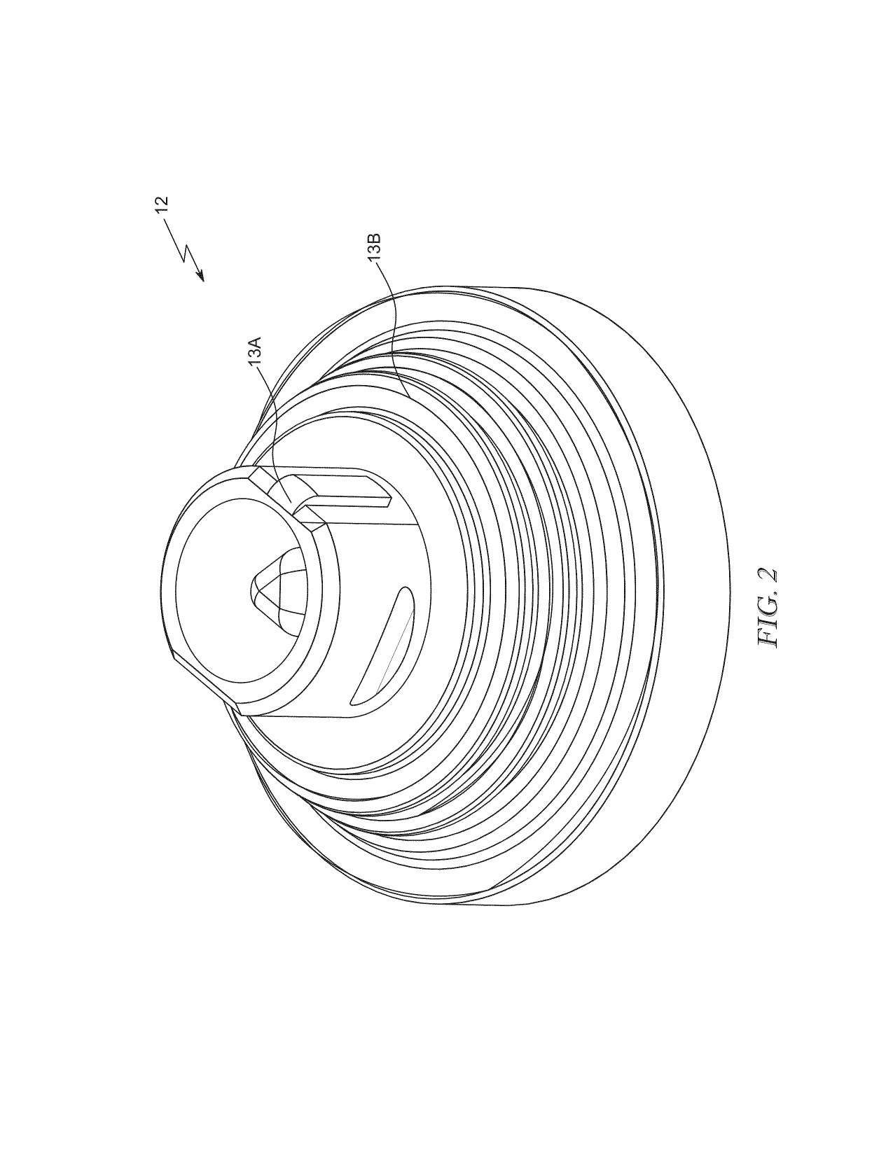

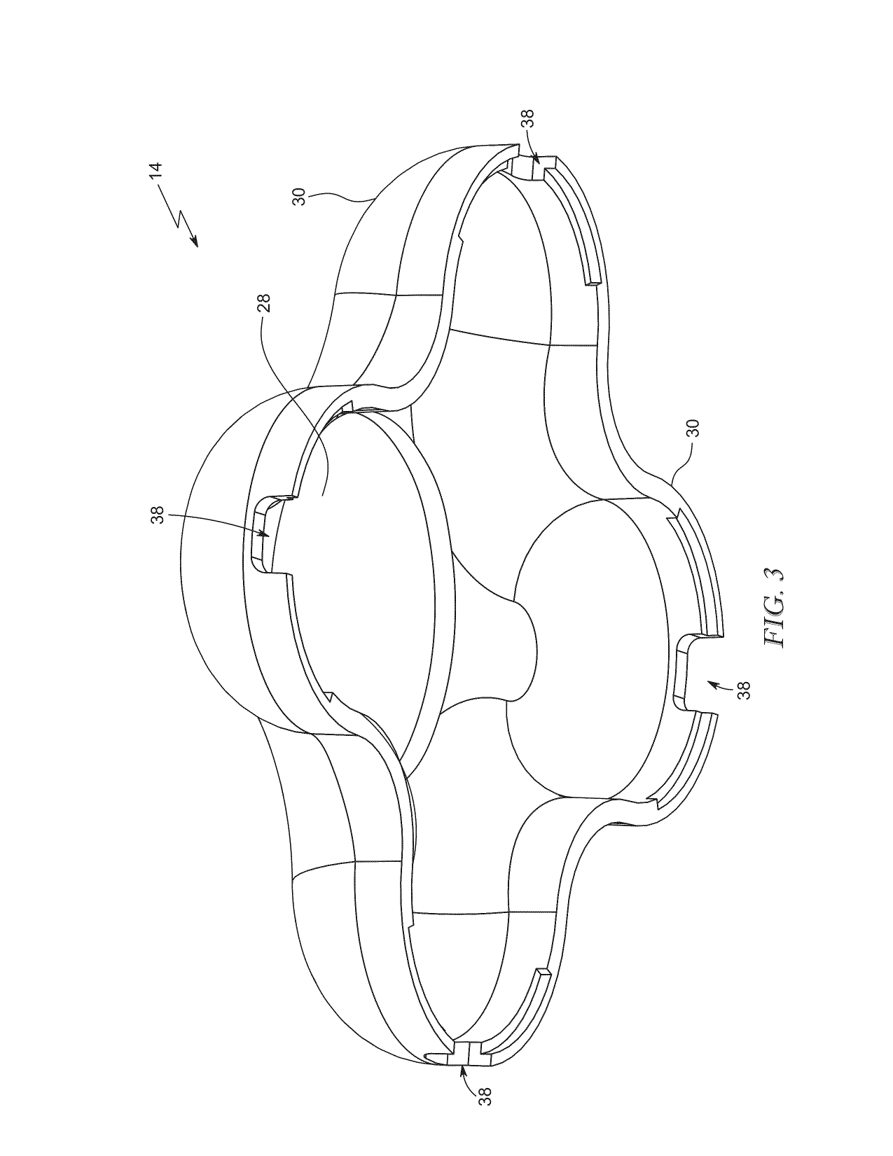

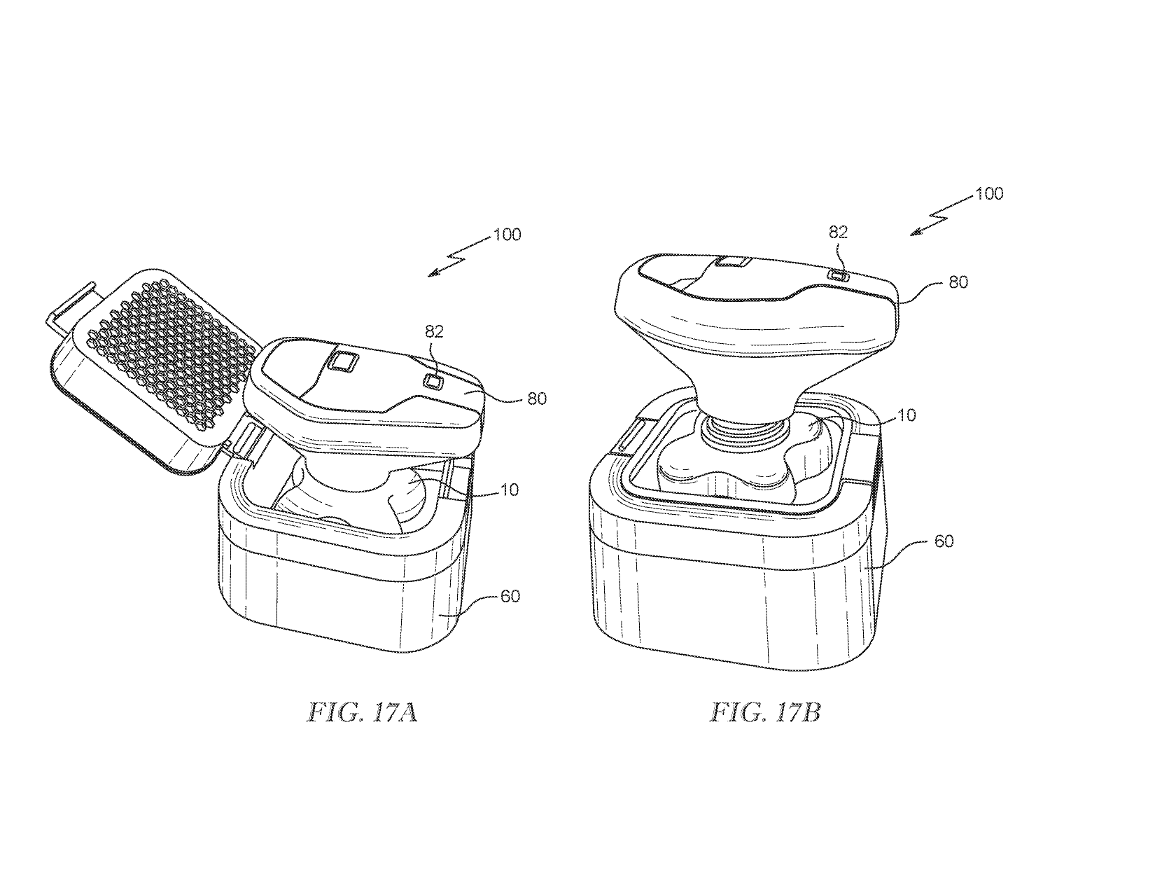

As shown in FIG. 2, the gear connection 12 includes a connection knob 13A positioned on an upper side of a base 13B of the gear connection 12, such that the connection knob 13 can be connected to the handle 80 (shown in FIGS. 17A-17B). The handle 80 can include a motor or other actuation means that is operably connected to the posts 18 of the gear housing cover 16 and configured to rotate the posts 18 so as to rotate the shaver blades 40 and the propellers 42. The base 13B of the gear connection 12 is configured to be insertable into an opening 28 formed in the gear housing 14, as shown in FIG. 3. In some embodiments, the opening 28 is formed centrally on a top side of the gear housing 14.

As can be seen in FIG. 3, the gear housing 14 comprises of a plurality of concave portions 30. In some embodiments, the gear housing 14 may include four concave portions 30 distributed evenly about the gear housing 14, as shown in FIG. 3. The number of concave portions 30 corresponds to the number of shaver head 40 and propeller 43 assemblies that are arranged within the concave portions 30, as will be described in greater detail below. As also shown in FIG. 3, each concave portion 30 includes a discharge opening 38 formed on outwardly facing sides of the concave portion 30.

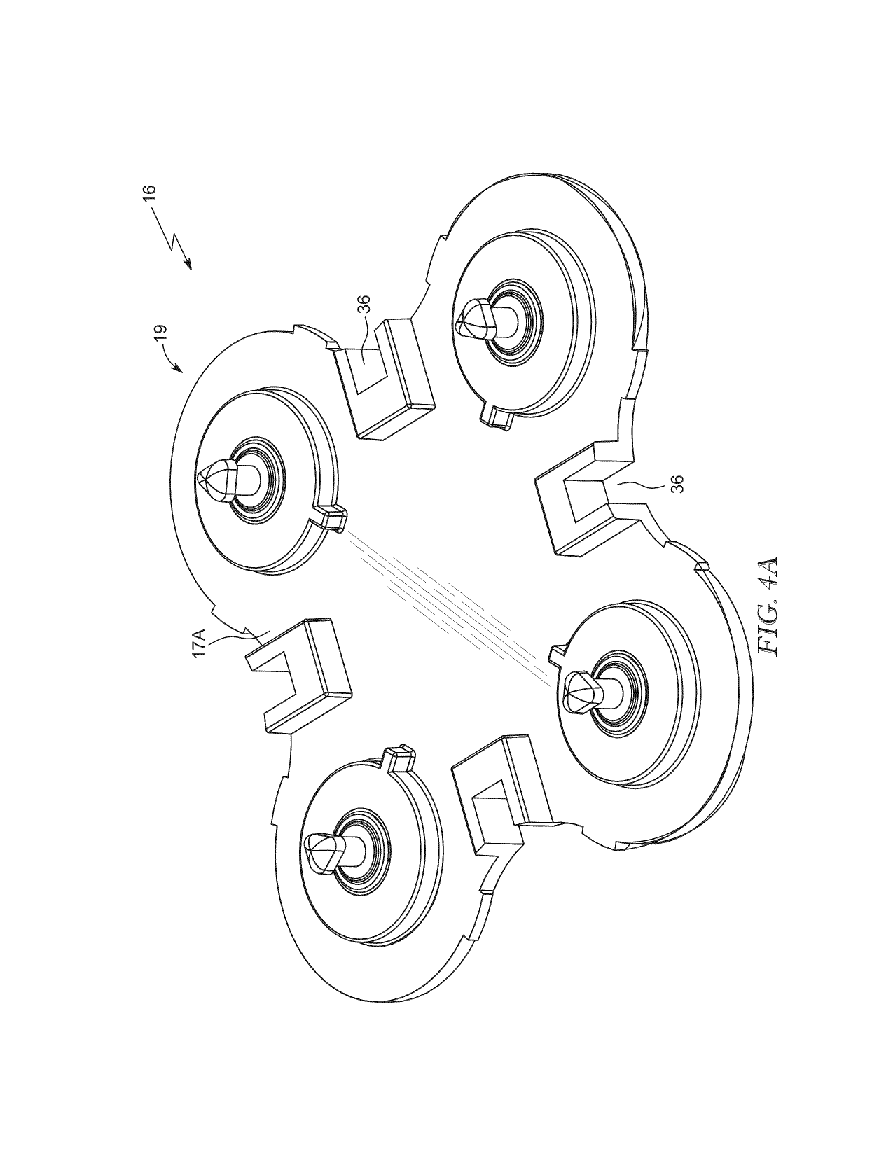

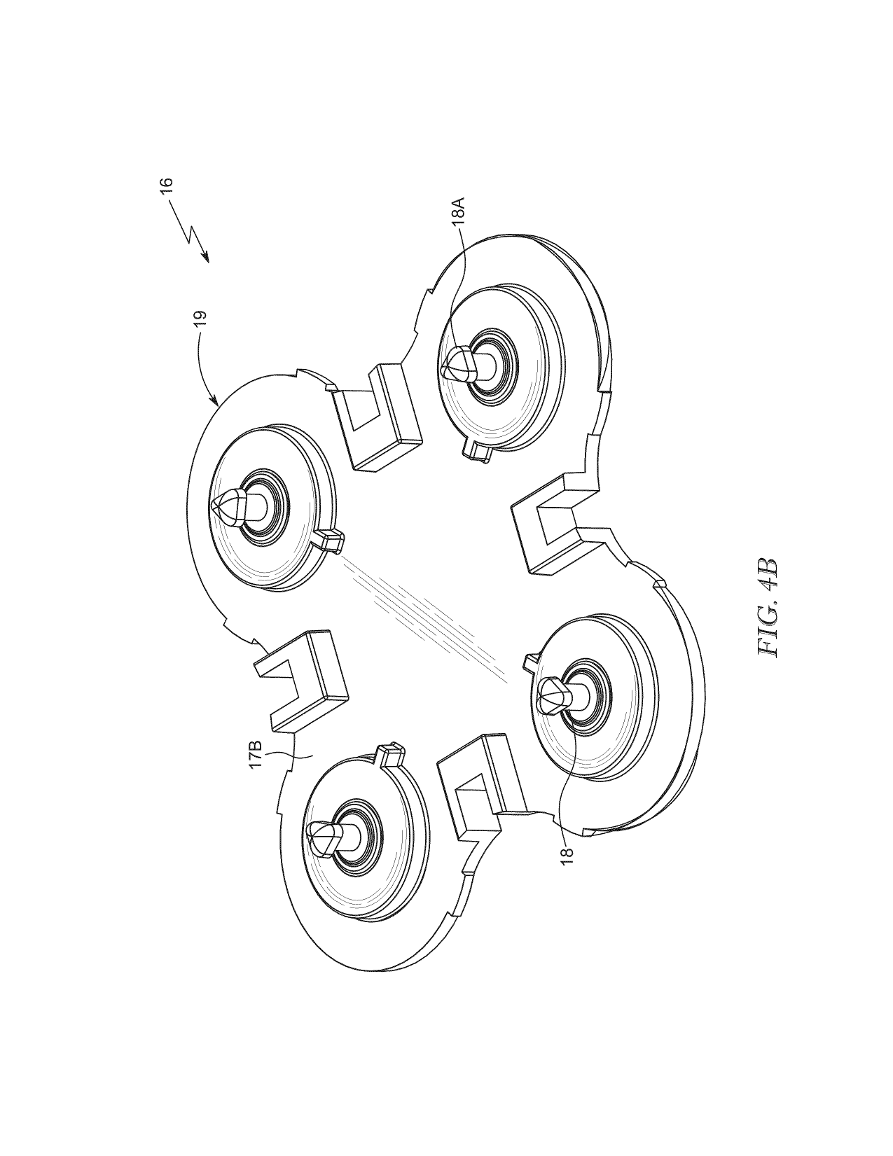

Referring now to FIGS. 4A and 4B, in an illustrative embodiment, the gear housing cover 16 is formed to have a corresponding shape to the gear housing 14, in particular having a plurality of post base portions 19 that correspond to the interior shape of the plurality of concave portions 30. Accordingly, each of the post base portions 19 fits within a corresponding concave portion 30 of the gear housing 14 and thus the gear housing cover 16 can be coupled within the gear housing 14. The upper side 17A of the gear housing cover 16 faces the gear housing 14, and the lower side 17B faces away from the gear housing 14. Illustratively, the gear housing cover 16 further includes a depression 36 formed between adjacent pairs of post base portions 19, as shown in FIGS. 4A and 4B. The depressions 36 are configured to receive corresponding protrusions 34 of the lower housing 22 so as to couple the lower housing 22 to the gear housing cover 16.

As can be seen in FIG. 4B, the gear housing cover 16 further includes a plurality of posts 18 arranged on the lower side 17B of the gear housing cover 16 and centrally on each of the post base portions 19. Each post 18 is rotatably arranged on the gear housing cover 16 and is operably connected to the motor or actuation means of the handle 80 so as to be rotated in a first rotational direction and a second rotational direction opposite the first rotational direction via the motor or actuation means. As viewed from the bottom of the shaver head 10, the shaver blades 40 positioned on the posts 18 are configured to spin in a counterclockwise rotation during the shaving mode and spin in a clockwise in the cleaning mode. In some embodiments, the direction of the shave blades 40 may be reversed by reversing direction of the motor in the handle 80. A PCB controller within the handle 80 can control the spin direction and speed of the motor during the shaving and cleaning modes. As will be described in greater detail below, each post 18 includes an enlarged tip 18A arranged at a terminal end of the post 18. The corresponding propeller 43 is configured to fixedly couple to the post 18, and in some embodiments, may snap onto the enlarged tip 18A of the post 18.

In the illustrative example, the shaver head 10 includes four shaver blade 40 and propeller 43 assemblies, and correspondingly four concave portions 30 formed in the gear housing 14 and four post base portions 19 formed in the gear housing cover 16. In other embodiments, the shaver head 10 may include a range of 1 to 8 shaver blade and propeller assemblies, including any number comprised therein. In some embodiments, the shaver head 10 may include more than 8 shaver blade and propeller assemblies.

Referring now to FIG. 5, in an illustrative embodiment, the lower housing 22 includes a plurality of openings 32 that are configured to align with the concave structures 30 of the gear housing 14 and the post base portions 19 of the gear housing cover 16. The openings 32 also each include two pivot posts 33 arranged the inner surface of the opening 32, as shown in FIG. 5. Specifically, the opening 32 is formed to be annular, and include a first post 33 arranged on the inner surface and a second post 33 arranged diametrically opposite of the first post 33. Each post 33 is configured to receive a pivot hole 53 of a foil base 54 of the foil assembly 50.

Each of the plurality of shaver blade 40 and propeller 43 assemblies is aligned with one of the openings 32 in the lower housing 22. A plurality of protrusions 34 extend upwardly away from an upper surface 22A of the lower housing 22, each of the protrusions 34 including a tab 34A configured to hook around a corresponding depression 36 in the gear housing cover 16 so as to couple the lower housing 22 to the gear housing cover 16. In some embodiments, the protrusions 34 may snap onto the gear housing cover 16 via the depressions 36.

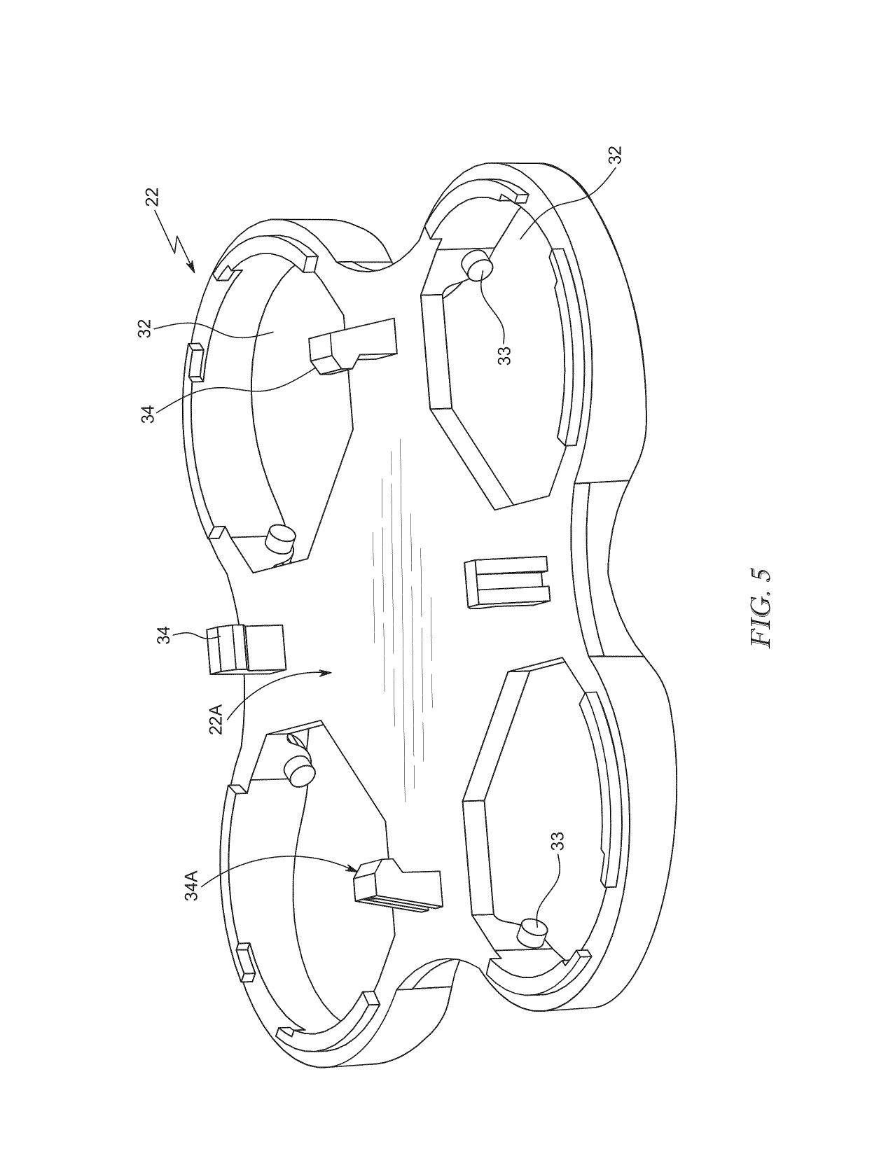

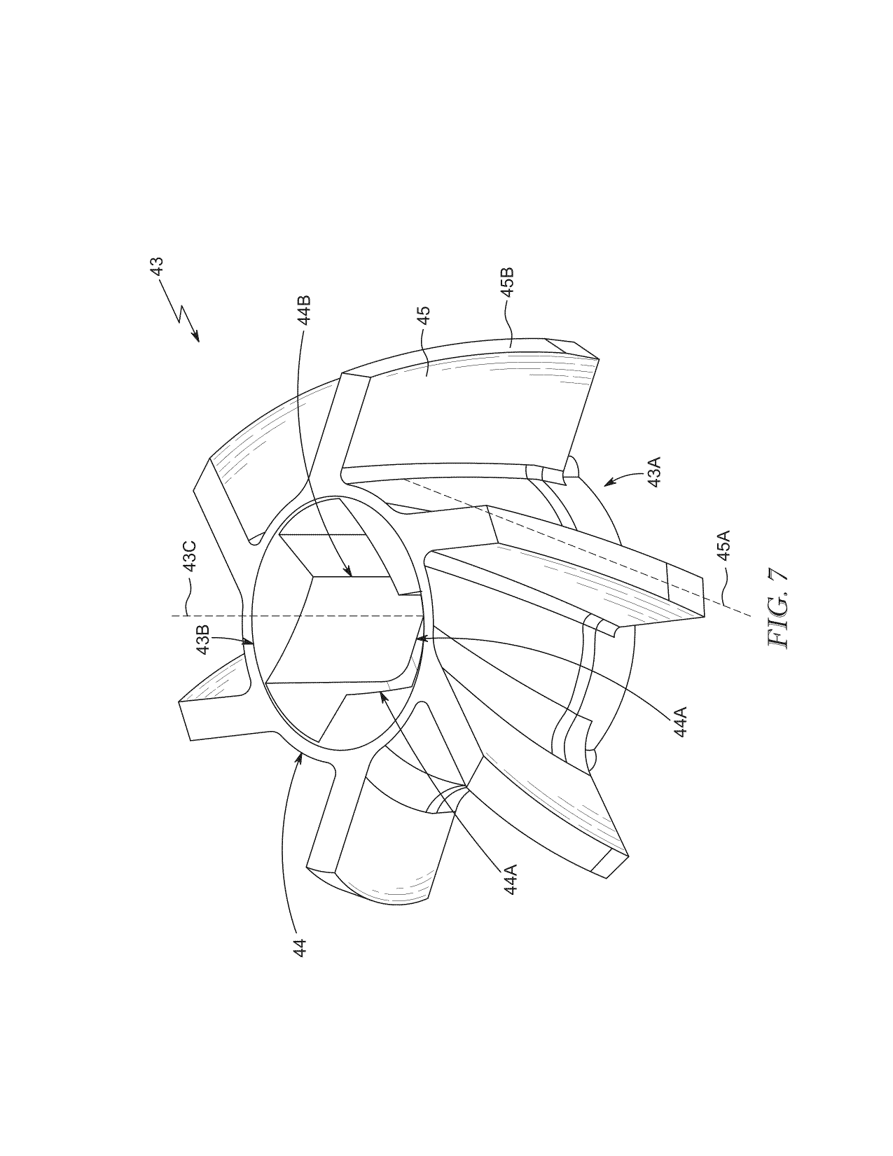

Referring now to FIGS. 6-8, in an illustrative embodiment, the shaver blade 40 includes an annular base 41 and a plurality of cutting blades 42 arranged in an annular configuration around the annular base 41. The cutting blades 42 may be angled relative to the annular base 41 such that the edges of the blades 42 can cut hair that the edges come into contact with when the shaver head 10 is in the shaving mode. In some embodiments, the shaver blades 40 may have alternate designs. As shown in FIG. 8, each shaver blade 40 is positioned on a corresponding propeller 43, which in turn is arranged on a corresponding post 18 of gear housing cover 16. In some embodiments, the propeller 43 is configured to be a part of the shaver blade 40 instead of being situated on the shaving blade 40. As will be described in detail below, the cutting blades 42 of the shaver blade 40 are configured to clip hair extending through a plurality of slots 58 of a foil 52 of the foil assembly 50 arranged beneath and adjacent to the cutting blades 42.

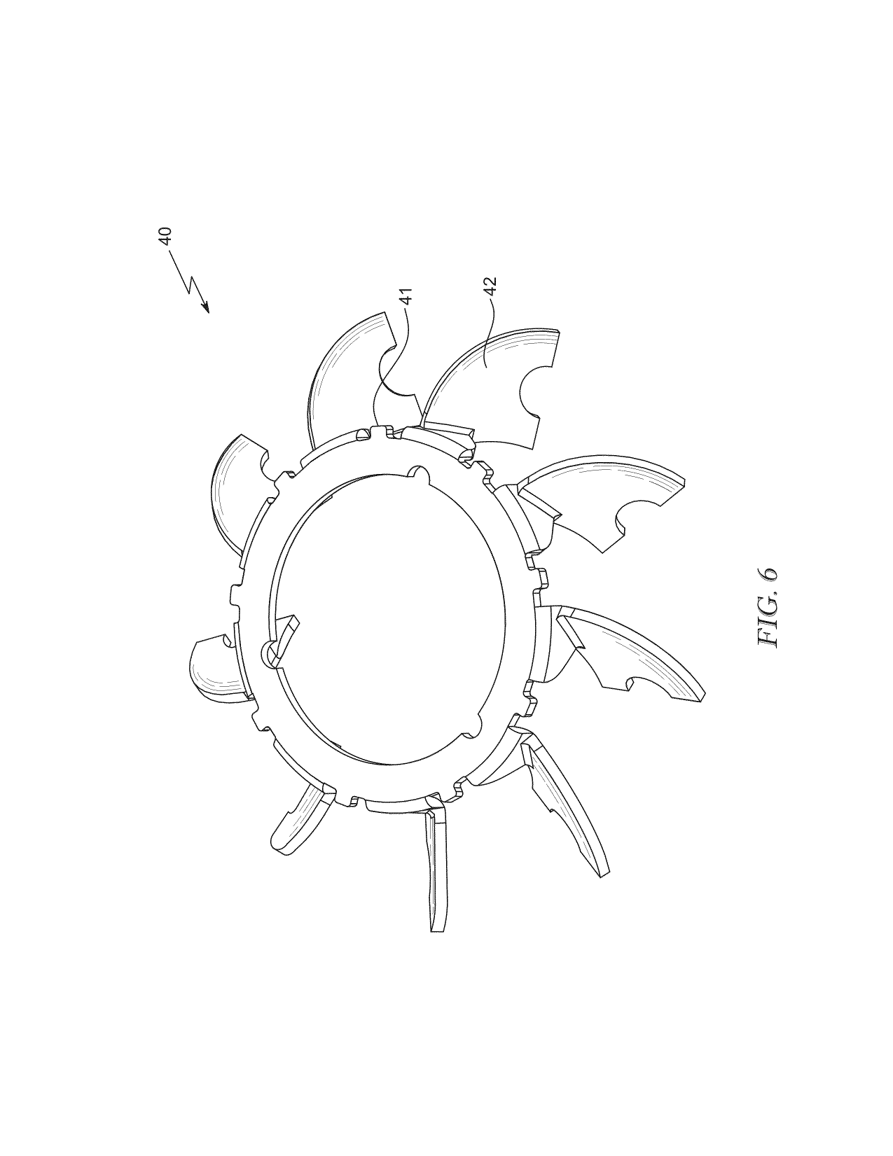

As shown in FIG. 7, the propeller 43 includes a lower side 43A, an upper side 43B opposite the lower side 43A, and a central axis 43C. The shaver blade 40 is arranged on the lower side 43A of the propeller 43. The propeller 43 includes a central cylindrical base 44 that has a central opening 44A extending axially therethrough, the central axis 43C of the propeller 43 being defined by the central axial axis of the central opening 44A, as shown in FIG. 7. A plurality of retention protrusions 44B are arranged within the central opening 44A and each include a ledge 44B that is configured to extend underneath the enlarged tip 18A of the post 18 on which the propeller 43 is arranged so as to couple the propeller 43 to the post 18.

The propeller 43 further includes a plurality of propeller blades 45 arranged in an annular configuration around the outer surface of the central cylindrical base 44. In some embodiments, the propeller 43 can include 6 propeller blades 45. The propeller blades 45 are spaced equidistant apart about the outer surface of the central cylindrical base 44. In some embodiments, each propeller blade 45 includes a slightly curved outer edge 45B.

As can be seen in in FIG. 7, each propeller blade 45 is angled relative to the central axis 43C of the propeller 43, illustrated by the line 45A. In some embodiments, the direction of the angle is the same as the direction of the angle of the cutting blades 42, as can be seen in FIG. 8 (i.e. from left to right in the upward direction). In some embodiments, each propeller blade 45 may be positioned at an angle in the range of about 15 degrees to about 50 degrees relative to the central axis 43C of the propeller 43, including any angle of range comprised therein. In some embodiments, each propeller blade 45 may be positioned at an angle in the range of about 15 degrees to about 20 degrees, about 20 degrees to about 25 degrees, about 25 degrees to about 30 degrees, about 30 degrees to about 35 degrees, about 35 degrees to about 40 degrees, about 40 degrees to about 45 degrees, or about 45 degrees to about 50 degrees relative to the central axis 43C of the propeller 43. In some embodiments, each propeller blade 45 may be positioned at an angle of about 25 degrees. In some embodiments, each propeller blade 45 may be positioned at an angle of about 30 degrees.

The angled nature of the propeller blades 45 enables the propellers 43 to draw liquid (specifically the fluid and/or cleaning fluid and/or water described herein) upwardly from the lower end 43A and toward the upper end 43B via rotation of the propeller 43 in a first rotational direction. The number of propeller blades 45 on the propeller 43 may depend on the diameter of the shaver blade 40. The angle and curvature of the propeller blades 45 may depend on the diameter of the shaver blade 40. The size of the propeller blades 45 may be sized according to the diameter of the shaver blade 40. The propeller 43 may be smaller than the diameter of the shaver blade 40 and may be configured to fit within the containment cylinder 46. As will be described in detail below, rotation of the propeller blades 45 on the propeller 43 in a first rotational direction enables the ejection of the fluid (e.g., cleaning liquid, water) from the discharge ports 48, thus removing hair clippings from the interior of the shaver head 10.

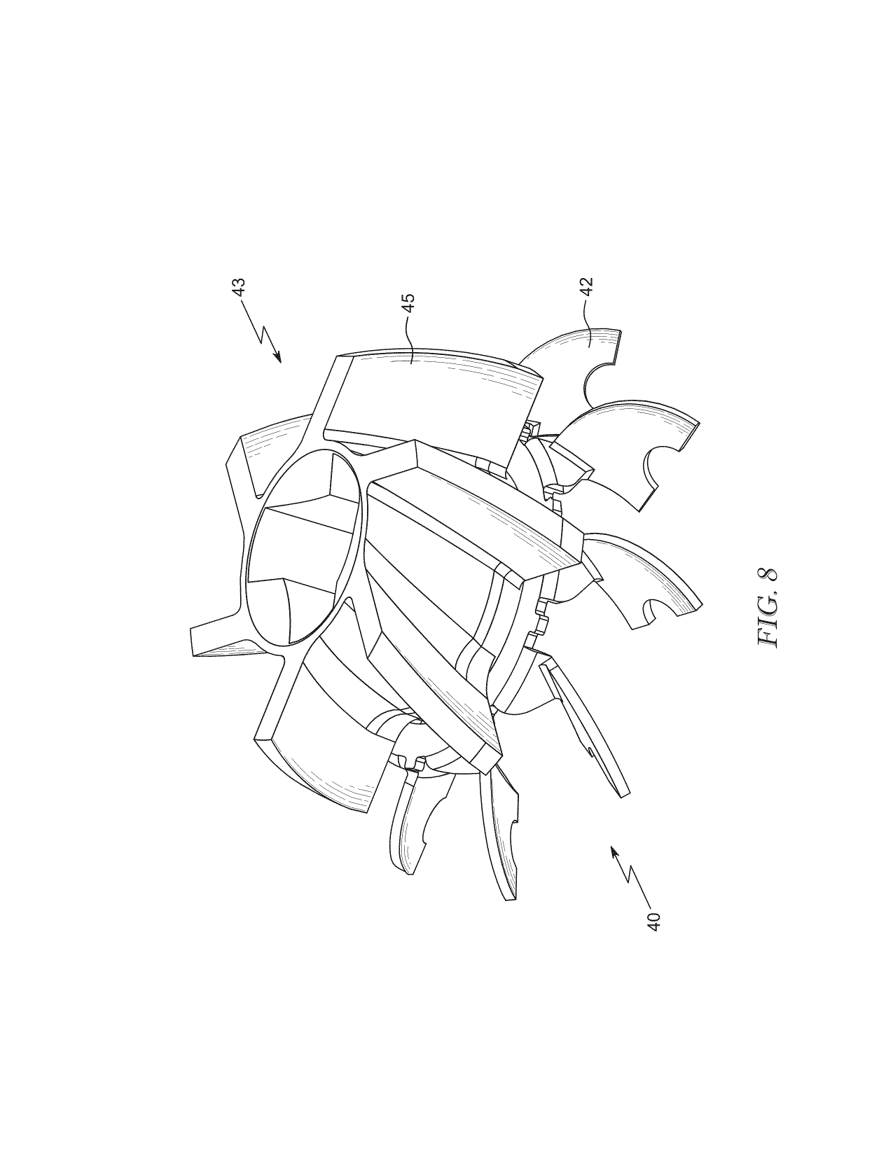

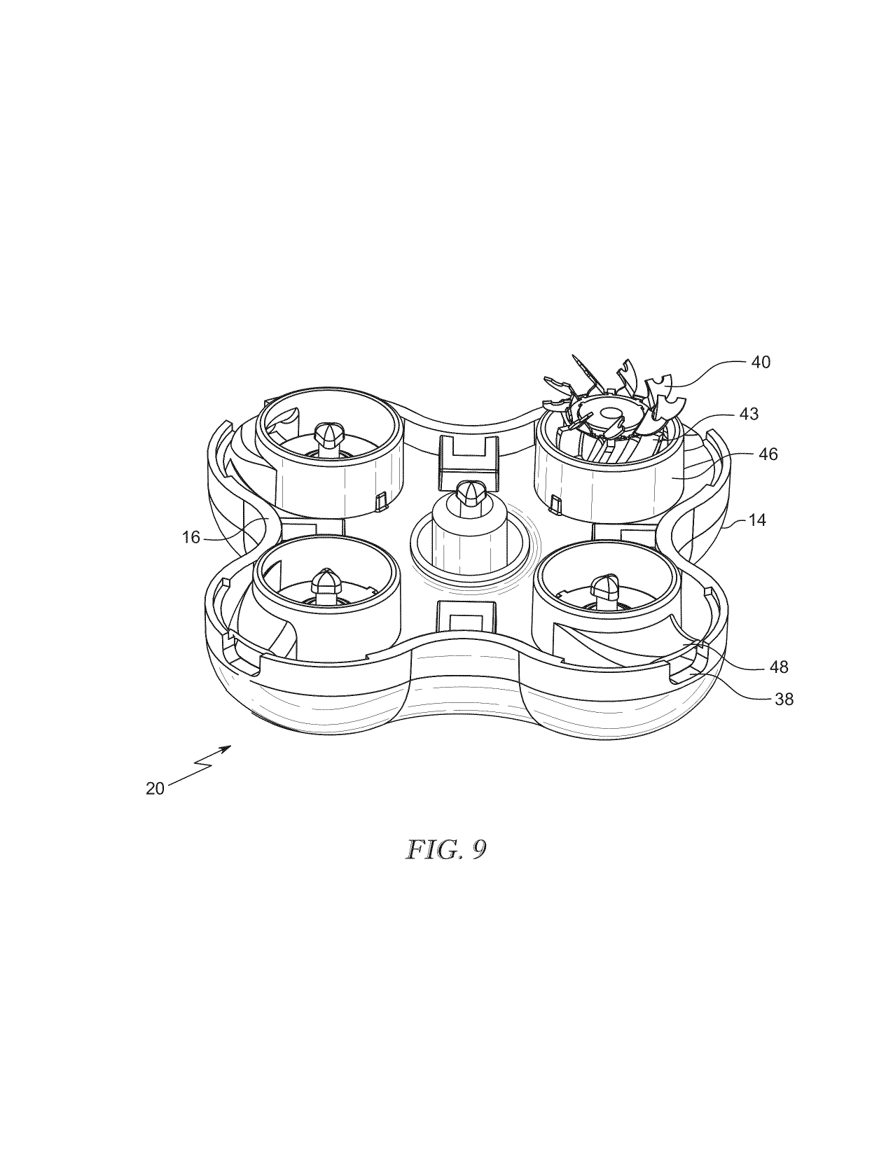

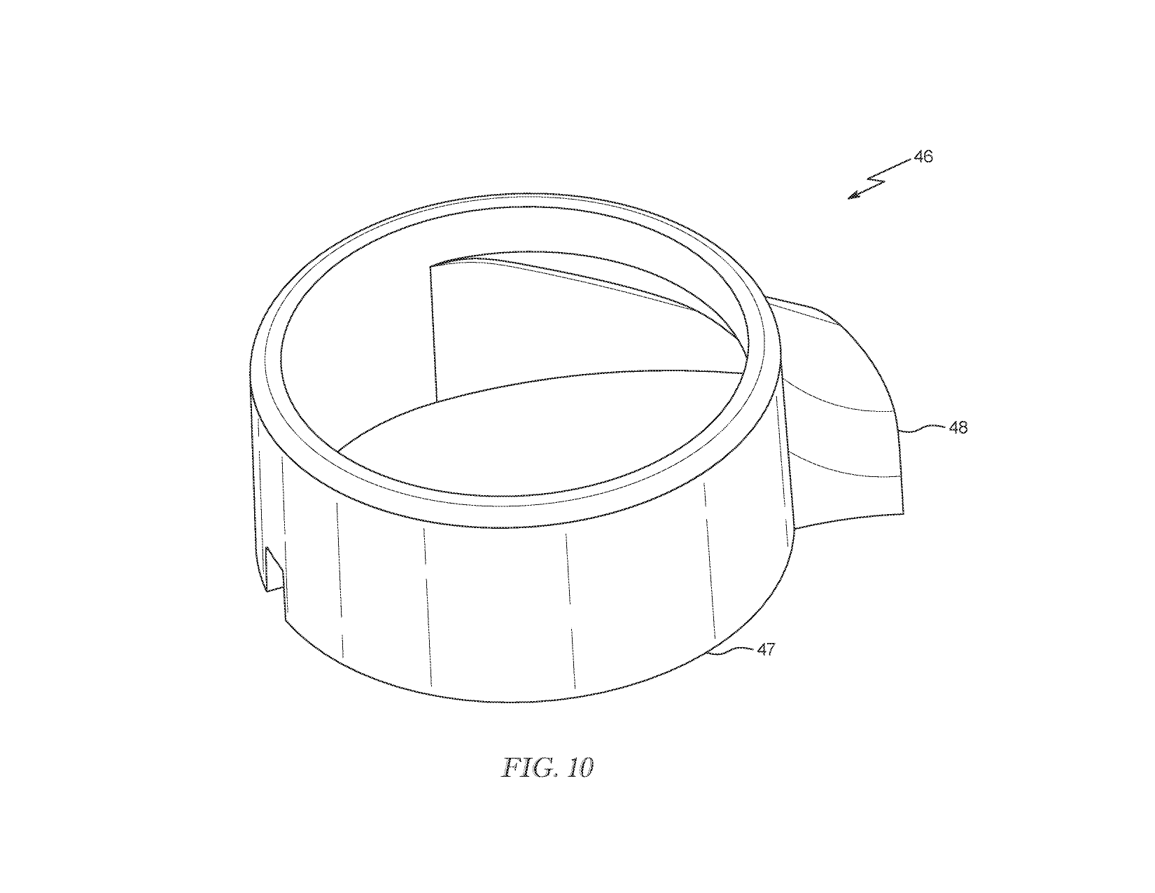

Referring now to FIGS. 9 and 10, in an illustrative embodiment, a plurality of containment cylinders 46 are coupled to the lower side 17B of the gear housing cover 16. Each containment cylinder 46 includes a cylindrical wall 47 and a discharge port 48 extending away from the cylindrical wall 47. The height of the discharge port 48 may extend partway along the height of the cylindrical wall 47, as can be seen in FIG. 9. In some embodiments, the height of the discharge port 48 may be approximately half of the height of the cylindrical wall 47.

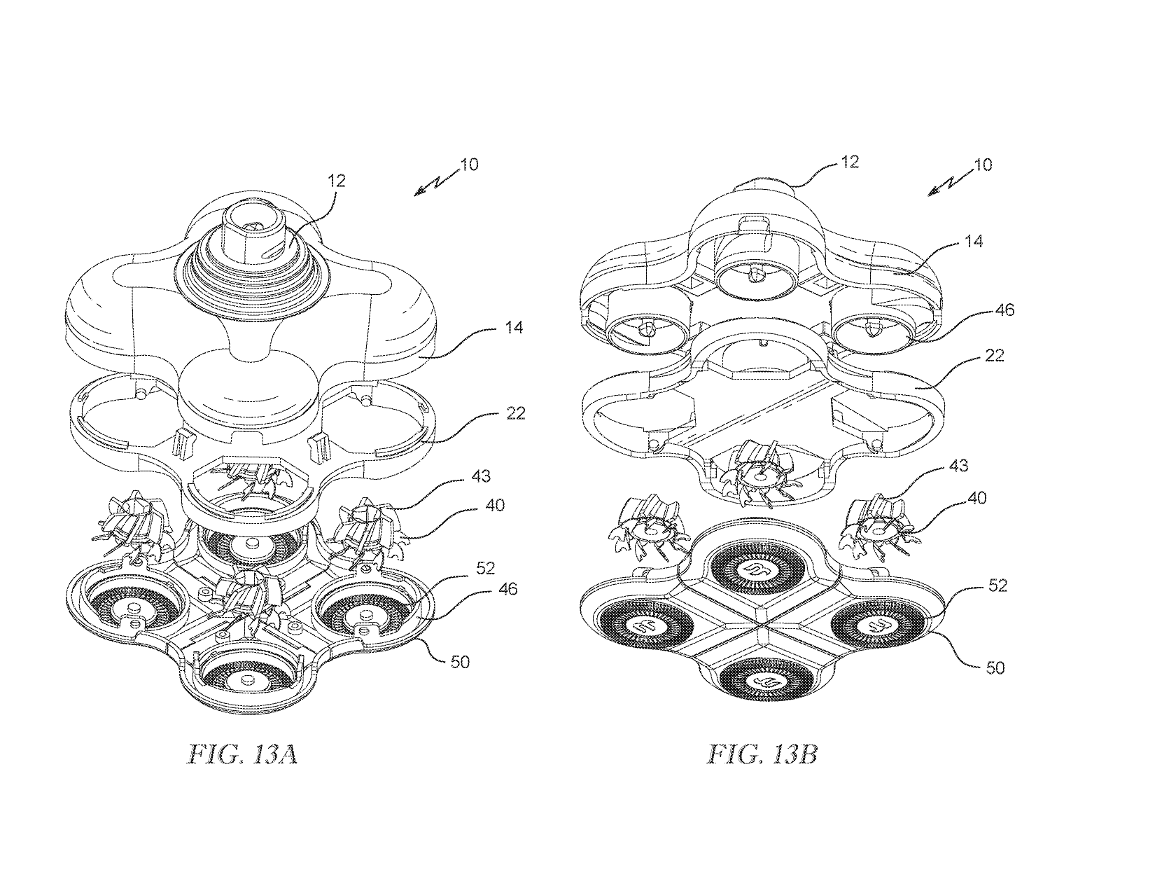

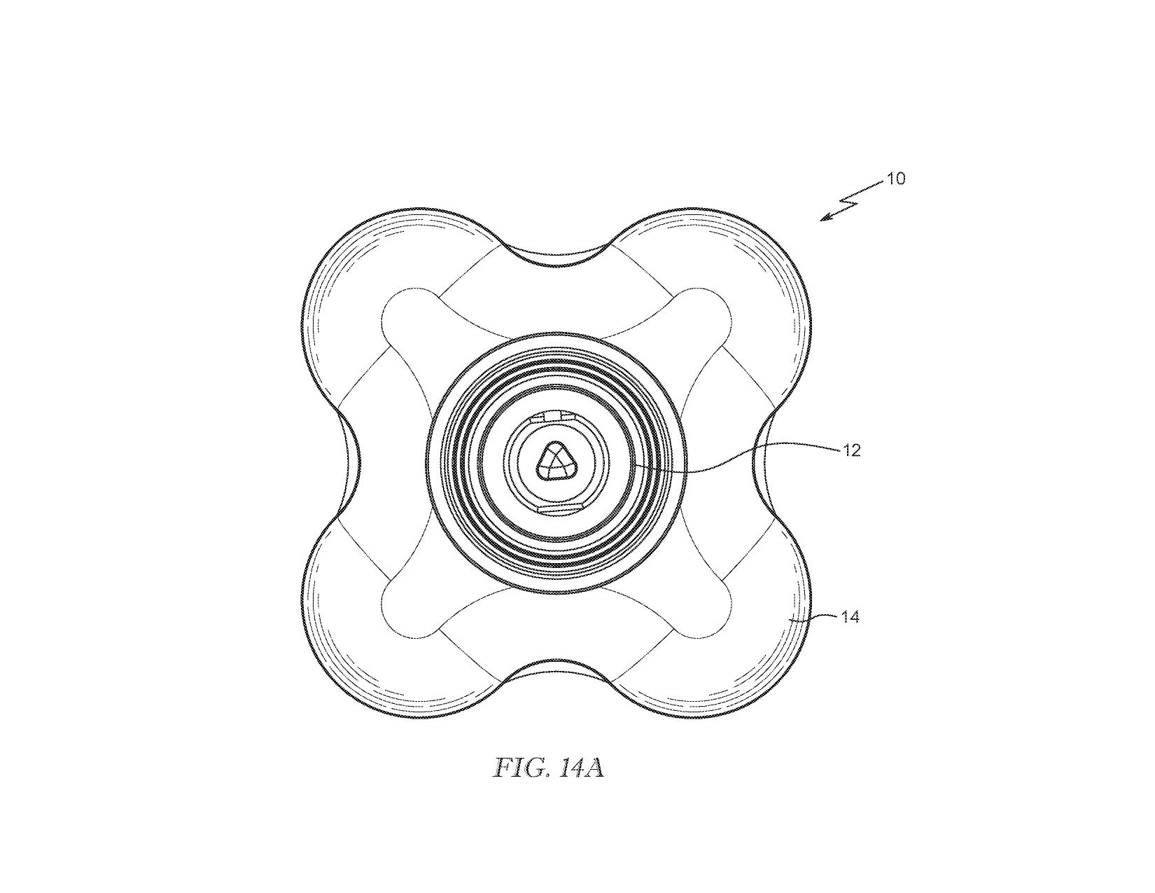

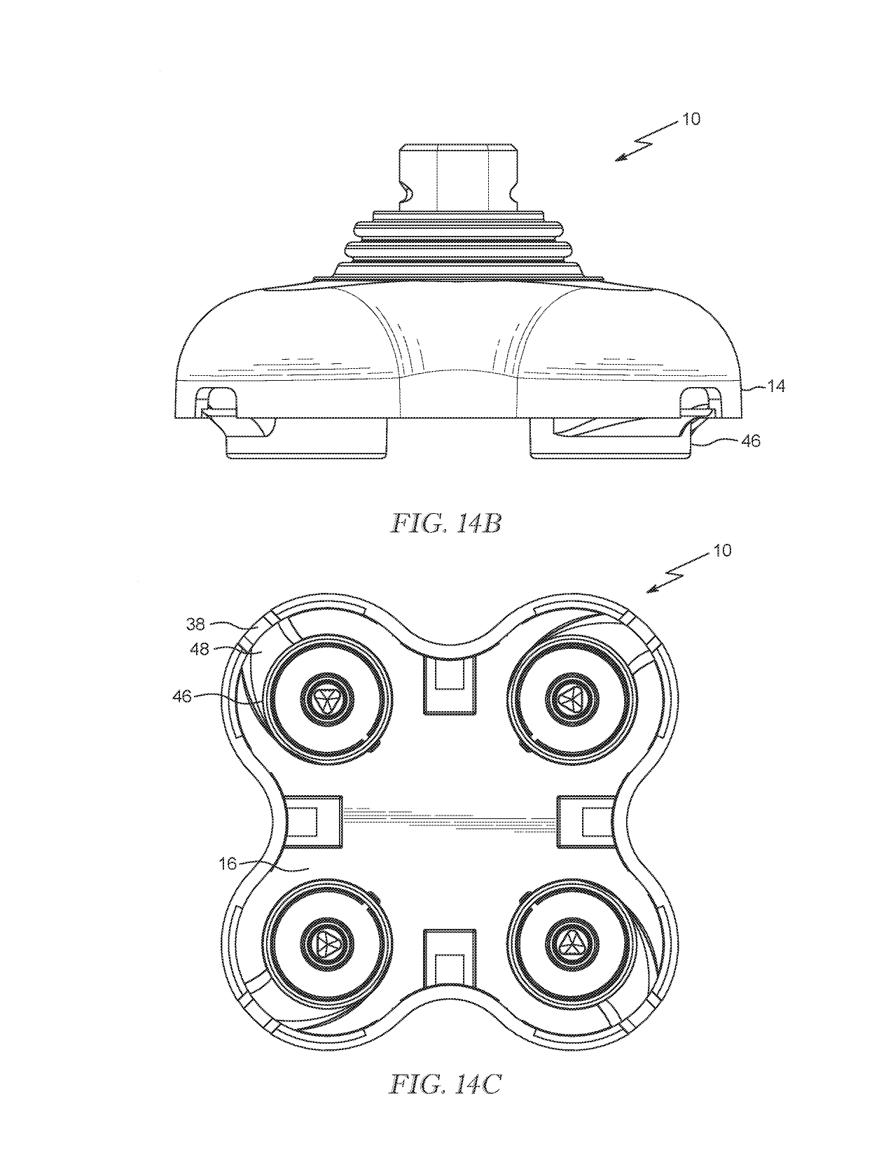

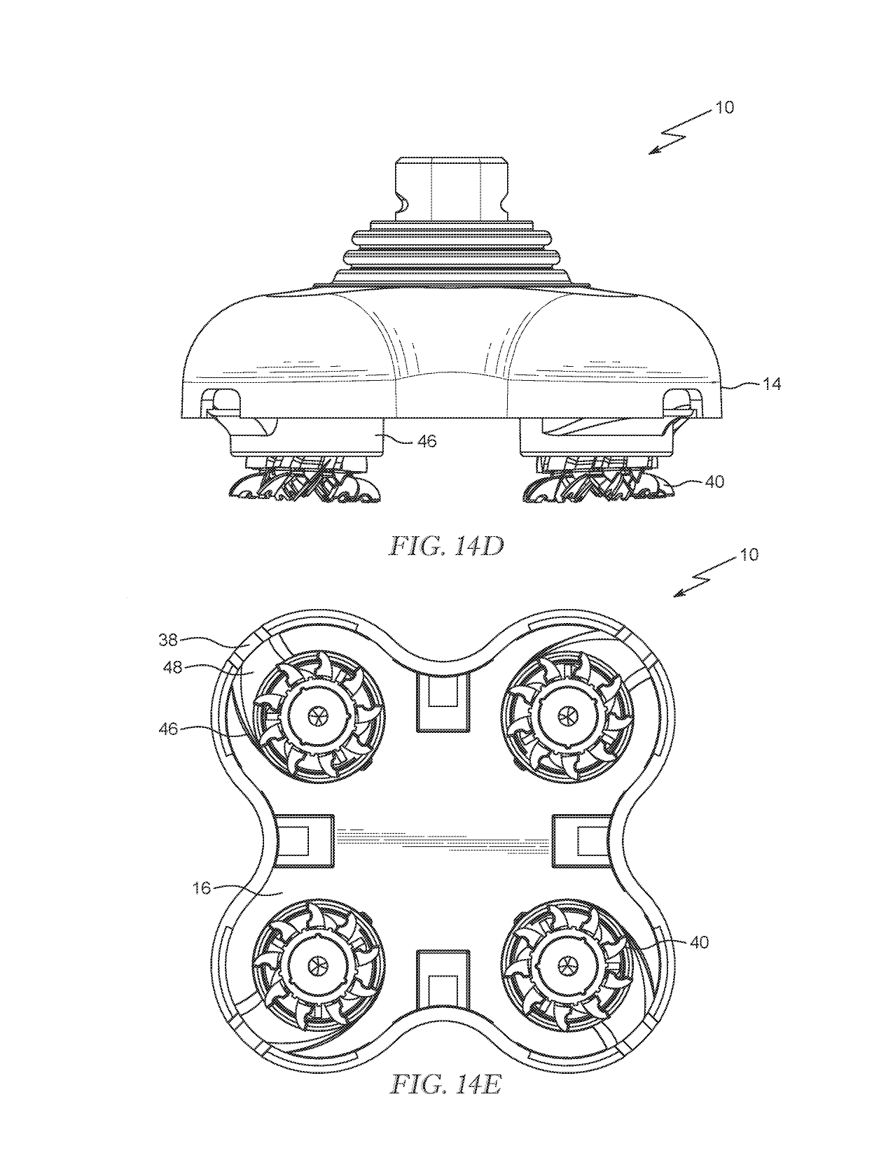

Each containment cylinder 46 surrounds a corresponding post 18 and propeller 43 of the shaver head 10, while the corresponding shaver blade 40 is arranged outside of the containment cylinder 46 so that the blades 42 can cut the hair extending through the foil assembly 50 (this can be seen in FIG. 14D). The containment cylinder 46 extends distally away from the gear housing cover 16 towards the lower housing 22 and extends into a corresponding opening 33 of the lower housing 22. As can be seen in FIG. 9, the radial extent of the propeller blades 45 comes close to the inner surface of the containment cylinder 46 but does not contact the inner surface. As can also be seen in FIG. 9, each discharge port 48 is aligned with a corresponding discharge opening 38 formed in the gear housing 14. As such, the discharge port 48 opens outwardly from the gear housing 14 via the discharge opening 38 so as to fluidically connect an interior of the containment cylinder 46 and an environment outside of the gear housing 14.

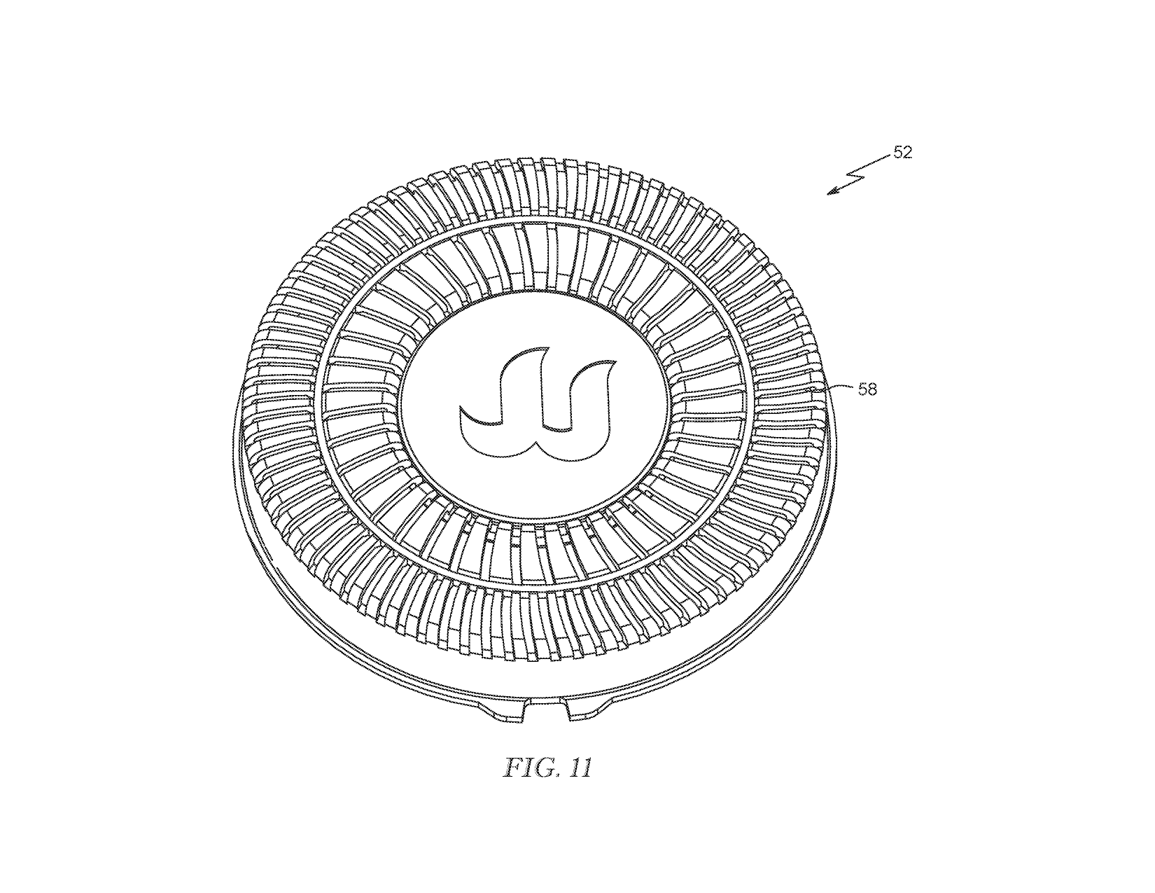

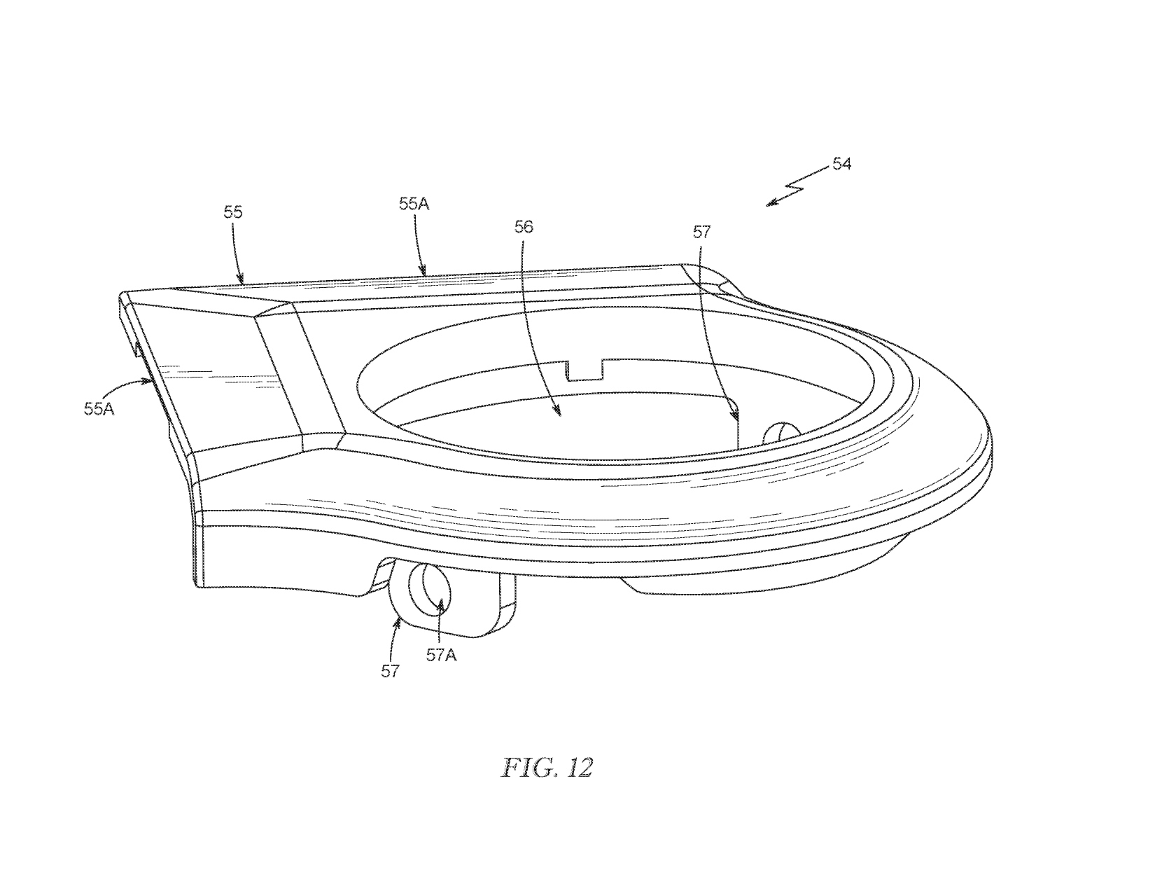

Referring now to FIGS. 11-13B, in an illustrative embodiment, the shaver head 10 further includes a foil assembly 50 include a plurality of foils 52, each foil 52 corresponding to a shaver blade 40. The foil assembly 50 includes a plurality of foil bases 54 (shown in FIG. 12) each having a base portion 55 and an opening 56 formed therein. Each base portion 55 can include inner edges 55A formed orthogonally to each other as shown in FIG. 12. Accordingly, the inner edges 55A of each base portion 55 can be arranged adjacent to each other so as to form a complete foil assembly 50 having four foils 52 that correspond to the four shaver blades 40, as shown in FIGS. 13A and 13B.

Illustratively, the foil base 54 further includes two pivot tabs 57 arranged diametrically opposite of each other directly adjacent to the opening 56 and extending upwardly from the base portion 55 (“upwardly” being in the downward direction in FIG. 12). Each tab 57 includes a pivot hole 57A configured to receive the pivot posts 33 of the lower housing 22 such that the foil bases 54 can pivot relative to the lower housing 22 and the gear housing 14. The pivoting of the bases 54 and thus the foils 52 allows the foils 52 to move based on the contour of the surface that they are running over during a shaving operation, such as the contour of a human head or human face. In some embodiments, the inner edges 55A may be pivotably coupled to each other so as to allow for additional play of the foil bases 54 when they pivot about the pivot posts 33 of the lower housing 22. As can be seen in FIGS. 13A and 13B, the foil 52 is arranged in the opening 56 of the foil base 54 and is aligned with a distal end of the containment cylinder 46 as well as aligned with the cutting blades 42 of the shaver blade 40. In a shaving mode, hair extends through slots 58 formed in the foil 52, and the cutting blades 42 move past the slots 58 and thus trim the hairs extending therethrough.

When the shaver head 10 has been used to trim hair, hair clippings build up within the shaver head 10, particularly on components such as the foils 52 and the shaver blades 40. In order to remove these hair clippings from the interior of the shaver head 10 without having to disassemble the shaver head 10, the shaver head 10 can be operated in a cleaning mode, as will be described below. In a cleaning mode, the propellers 43 and the shaver blades 40 are rotated in a first rotational direction which is opposite of a second rotational direction in which the propellers 43 and the shaver blades 40 rotate in the shaving mode. The button 82 on the handle 80 is configured to switch the motor or actuation means of the handle 80 between the first and second rotational directions (i.e. between the cleaning and shaving modes).

In a cleaning mode, the shaver head 10 is partially submerged in a fluid (e.g., cleaning liquid, water) and the propellers 43 are rotated in the first rotational direction. This rotation causes the propellers 43 to draw the fluid upwardly though the foils 52 of the foil assembly 50, over the cutting blades 42 of the shaver blades 40, and into the containment cylinder 46. The fluid flowing over the foils 52 and the cutting blades 42 removes hair clippings therefrom and can remove hair clippings from other surfaces as well, such as surfaces of the foil assembly 50, the shaver blades 40, the propeller blades 45, and the containment cylinder 46. Due to the containment cylinder 46 surrounding the propeller 43, the fluid with the hair clippings is contained within the interior of the containment cylinder 46. Acting similarly to a ducted fan, the containment cylinder 46 directs the fluid through the cylinder 46 and outwardly through the discharge port 48 and out of the gear housing 14 via the discharge opening 38, thereby minimizing any functional issues that may arise in the shaver head 10 due to inefficient cleaning of hair clippings. As can be seen in FIG. 9, the discharge opening 38 on the side of gear housing 14 is positioned to align with the discharge port 48 of the containment cylinder 46 to enable the removal of hair trimmings from the shaver head 10.

As described above, FIGS. 13A and 13B illustrate an exploded view of the shaver head 10 including the gear housing assembly 20, the shaver blades 40, and the foil assembly 50. Each component of the shaver head 10 is configured to be disassembled and reassembled. FIGS. 14A-14E illustrate the different views of the shaver head 10 comprising the gear connection 12, the gear housing 14, the gear housing cover 16, and the lower housing 22. FIGS. 14D and 14E illustrate the shaver head 10 with the shaver blades 40 attached. FIGS. 14B and 14C illustrate the shaver head 10 without the shaver blades 40 attached. FIG. 14A shows a top view of the shaver head 10, illustrating the gear connection 12 and the gear housing 14. FIG. 14B shows a side view and FIG. 14C shows a bottom view of the shaver head 10 when not being used since the shaver blades 40 are not attached. As is illustrated in FIGS. 14D and 14E, the shaver blades 40 extend out of the containment cylinder 46 when the shaver head 10 is in use.

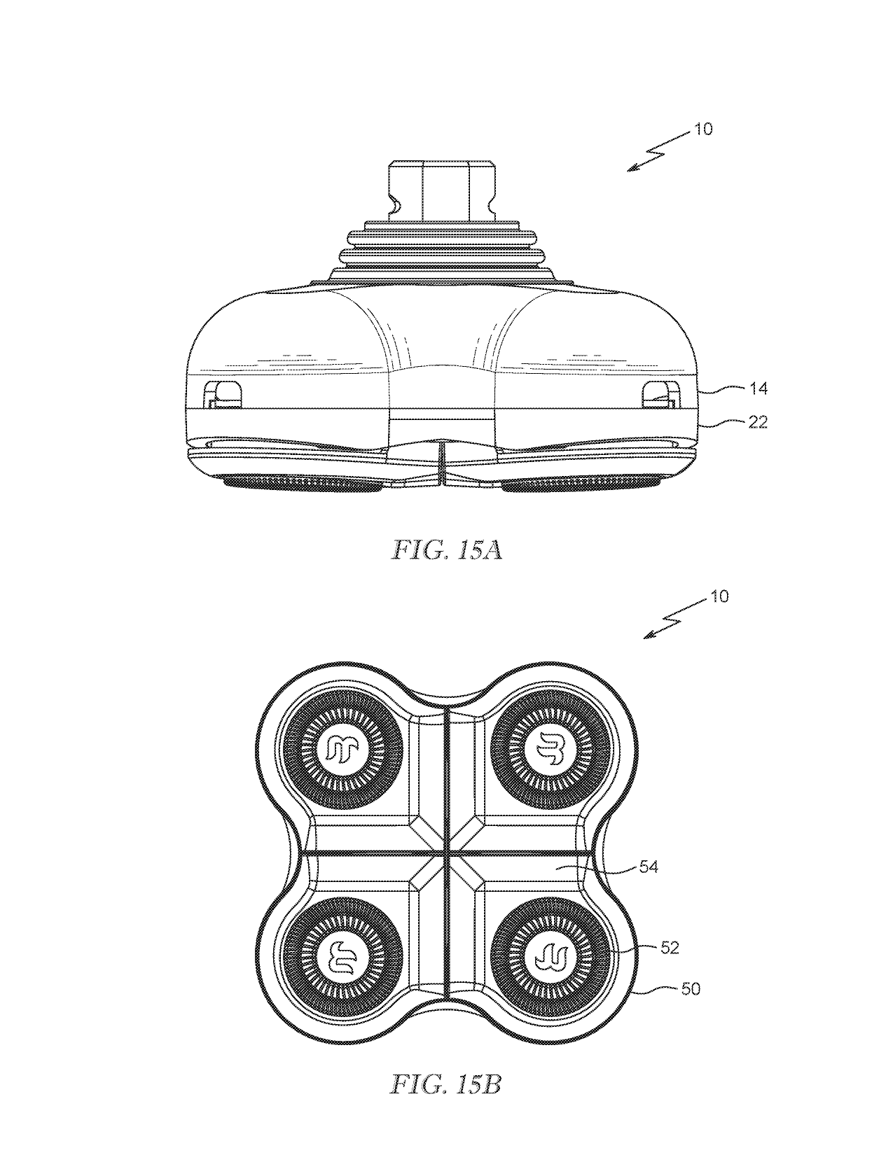

FIGS. 15A and 15B illustrate side and bottom views of the shaver head 10 comprising the gear connection 12, the gear housing 14, lower housing 22, foils 52 of the foil assembly 50, and foil bases 54 of the foil assembly 50. FIG. 15A.

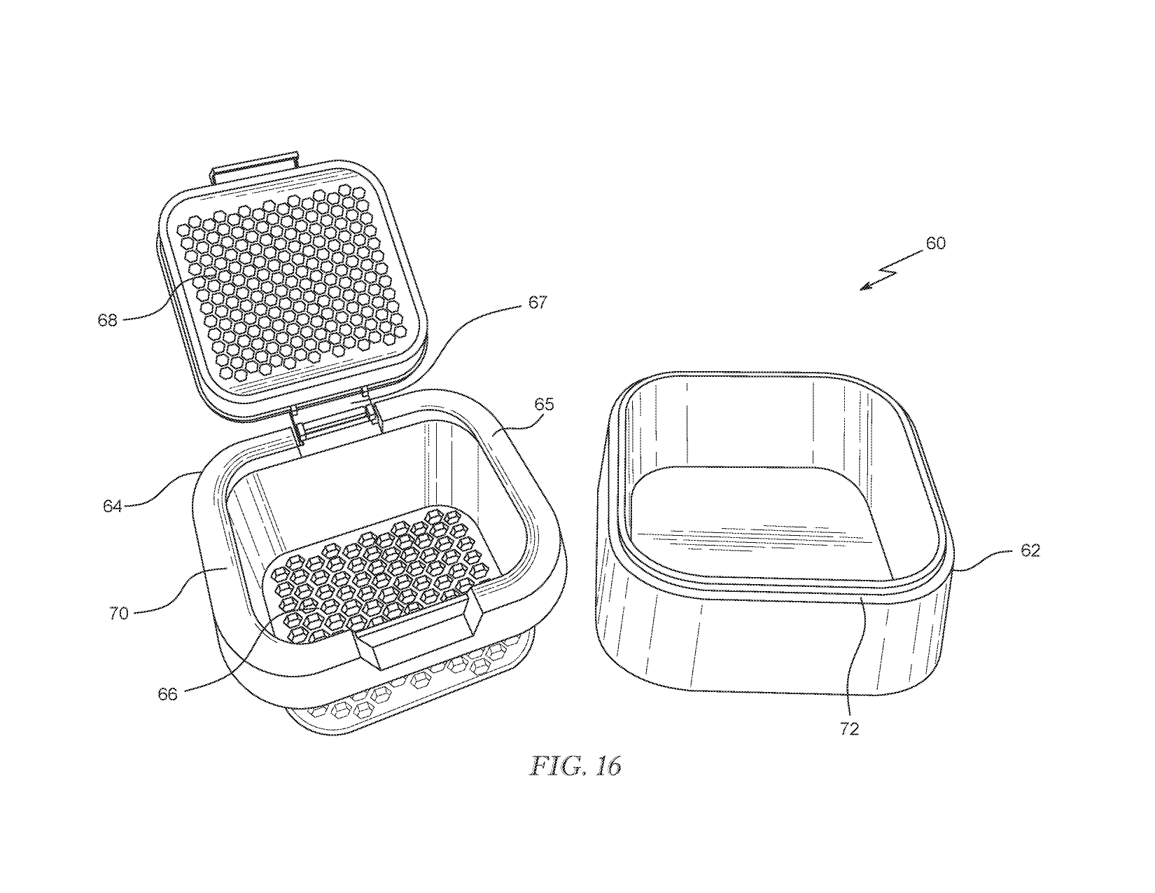

Referring now to FIG. 16, in an illustrative embodiment, a cleaning assembly 60 includes a cleaning and drying container 64 configured to be positioned in a cleaning base container 62. The cleaning and drying container 64 includes a grated tray bottom 66 configured to enhance the circulation of fluid (e.g., cleaning liquid, water) into the slots 58 of the foil 52 and into the containment cylinder 46 of the shaver head 10, as will be described below. The cleaning and drying container 64 is configured to be placed in the cleaning base container 62 such that the grated tray bottom 66 is positioned in the cleaning base container 62 at minimal height above a bottom 62 of the cleaning base container 62. Cleaning base container 62 can have a fill line indicating the level of fluid that should be used in the cleaning tray-visible in FIG. 16 on 62. In this way, the grated tray bottom 66 can be submerged in the fluid contained in the base container 62 so that the fluid may flow through the grates of the grated tray bottom 66 and freely into the foils 52 via suction created by the propellers 43.

In order to arrange the cleaning and drying container 64 in the cleaning base container 62, the cleaning and drying container 64 includes a U-shaped channel 70 extending around a perimeter of a top edge 65 of the cleaning and drying container 64, the U-shaped channel 70 being configured to receive an upper perimeter edge 72 of the cleaning base container 62 such that the cleaning and drying container 64 is supported within the cleaning base container 62 by the upper perimeter edge 72. The cleaning and drying container 64 further includes a drying tray 68 pivotably coupled to a side wall of the cleaning and drying container 64 via a hinge 67. The dying tray 68 is configured to be pivoted between a non-use position (shown in FIGS. 16 and 17A) and a use position (shown in FIG. 17B) in which the drying tray 68 is disposed at a height above the grated tray bottom 66.

As shown in FIGS. 17A and 17B, the shaver head 10 is connected to the handle 80 and placed in the cleaning assembly 60 when operating in the cleaning mode (FIG. 17A) and drying mode (FIG. 17B). During the cleaning mode, actuated by button 82, the shaver 10 will run in an automated fashion lasting for a pre-determined duration of time. During the cleaning mode, the shaver blades 40 are configured to spin at various speeds and may change directions and pulse speeds to help remove and dislodge hair. When completed, the handle 80 may emit a sound to indicate to the user that the cleaning mode is complete. During the drying mode, actuated by button 82, the shaver head 10 will run in an automated fashion lasting for a pre-determined duration of time. The drying mode may include periods of high RPM rotation and periods of rest. When completed, the handle 80 may emit a sound to indicate to the user that the drying mode is complete.

A lower surface of the shaver head 10 defined by the foil assembly 50, in particular by the foils 52, rests on the grated tray 66 of the cleaning and drying container 64 during the cleaning mode and rests on the drying tray 68 during the drying mode. The drying tray 68 may be arranged above a fluid line of the fluid arranged in the cleaning base container 62.

When the shaving system is operating in the cleaning mode, the cleaning base container 62 is configured to be filled with the fluid (e.g., cleaning liquid, water) such that at least some of the fluid is above the grated tray bottom 66 but below the height of the drying tray 68. The fluid may be drawn up by the propellers 43 of the shaver head 10 in response to the rotation of the propeller 43 in the first rotational direction of the cleaning mode. The fluid passes through the grated tray bottom 66 and can accumulate in the cleaning base container 62 after having passed through the components of the interior of the shaver head 10.

When the shaver head 10 is operating in the cleaning mode, as shown in FIG. 17A, the fluid may be recirculated repeatedly through the shaver head 10 in the cleaning and drying container 64. When the shaver head 10 is operating in the drying mode, as shown in FIG. 17B, the shaver head 10 is allowed to dry on the drying tray 68 without any water recirculation. The drying mode may also be selectable by the button 82 and is a mode in which the motor or actuation means does not rotate the propellers 43 and shaver heads 40. In some embodiments, in the drying mode, the shaver blades 40 may spin intermittently.

While the disclosure has been illustrated and described in detail in the drawings and foregoing description, such an illustration and description is to be considered as illustrative and not restrictive in character, it being understood that only illustrative embodiments have been shown and described and that all changes and modifications that come within the spirit of the disclosure are desired to be protected.

There is a plurality of advantages of the present disclosure arising from the various features of the methods, apparatuses, and systems described herein. It will be noted that alternative embodiments of the methods, apparatuses, and systems of the present disclosure may not include all of the features described yet still benefit from at least some of the advantages of such features. Those of ordinary skill in the art may readily devise their own implementations of the methods, apparatuses, and systems that incorporate one or more of the features of the present invention and fall within the spirit and scope of the present disclosure as defined by the appended claims.

1. A shaving system comprising:
a shaver head including:
a gear housing cover;
a gear housing positioned on an upper side of the gear housing cover;
a foil assembly arranged on a lower side of the gear housing cover opposite the upper side;
at least one shaver blade including a plurality of cutting blades arranged in an annular configuration, the at least one shaver blade being positioned on a post located on the gear housing cover and configured to rotate with the post, the at least one shaver blade being aligned with an opening formed in the foil assembly so as to enable the at least one shaver blade to clip hair extending through the opening;
a propeller including a plurality of the propeller blades, the propeller being attached to an upper side of the at least one shaver blade,
a containment cylinder including a proximal end attached to the gear housing cover and surrounding the post and the propeller, the containment cylinder further including at least one discharge port that opens outwardly from the gear housing so as to fluidically connect an interior of the containment cylinder and an environment outside of the gear housing,
wherein, in response to the shaver head being at least partially submerged in a fluid, rotation of the propeller in a first rotational direction draws the fluid upwardly through the opening of the foil assembly, into the containment cylinder, and outwardly through the at least one discharge port such that the fluid flows over the at least one shaver blade and removes hair clippings therefrom.

2. The shaving system of claim 1, further comprising:
a cleaning assembly including a cleaning and drying container having a grated tray bottom, the cleaning and drying container configured to be positioned in a cleaning base container.

3. The shaving system of claim 2, wherein the grated tray bottom of the cleaning and drying container is positioned in the cleaning base container at minimal height from a bottom of the cleaning base container, wherein cleaning base container is configured to receive the fluid therein and is configured to be filled with the fluid such that at least some of the fluid is above the grated tray bottom, and wherein a lower surface of the foil assembly of the shaver head is configured to rest on the grated tray bottom such that the fluid may be drawn up by the propeller of the shaver head in response to the rotation of the propeller in the first rotational direction.

4. The shaving system of claim 3, wherein the cleaning and drying container further includes a U-shaped channel extending around a perimeter of the cleaning and drying container that is configured to receive an upper perimeter edge of the cleaning base container such that the cleaning and drying container is supported within the cleaning base container by the upper perimeter edge.

5. The shaving system of claim 4, wherein the cleaning and drying container further includes a drying tray pivotably coupled to a side wall of the cleaning and drying container, and wherein the dying tray is configured to be pivoted between a non-use position and a use position in which the drying tray is disposed at a first height above the grated tray bottom.

6. The shaving system of claim 1, wherein the shaver head is configured to be attached to a handle, wherein the handle is operable to selectively operate the shaver head in a cleaning mode and in a shaving mode.

7. The shaving system of claim 6, wherein, when the shaving system is operating in the cleaning mode, the plurality of propeller blades of the propeller rotate in the first rotational direction so as to draw the fluid upwardly through the opening of the foil assembly, into the containment cylinder, and outwardly through the at least one discharge port.

8. The shaving system of claim 7, wherein, when the shaving head is operating in the shaving mode, the plurality of propeller blades of the propeller are configured to rotate in a second rotational direction opposite the first rotational direction such that the at least one shaver blade is configured to clip hair extending through the opening of the foil assembly.

9. The shaving system of claim 1, further comprising:
a lower housing arranged between the gear housing cover and the foil assembly and attached to the gear housing cover, the lower housing including at least one opening aligned with the propeller and the at least one shaver blade, the at least one opening including two pivot posts arranged on an inner surface of the at least one opening and spaced apart from each other,
wherein the foil assembly further includes at least one foil base having an opening that defines the opening of the foil assembly, the foil base further including two pivot tabs extending upwardly from a base portion of the foil base, and wherein the two pivot tabs each include a pivot hole that receives one of the two pivot posts of the lower housing so as to enable pivoting of the foil base relative to the lower housing.

10. A shaver head comprising:
a gear housing assembly including at least one discharge opening;
a foil assembly arranged under the gear housing assembly and including at least one opening;
at least one shaver blade rotatably coupled to the gear housing assembly; and
a propeller including a plurality of the propeller blades, the propeller being attached to an upper side of the at least one shaver blade, the at least one shaver blade and the propeller being aligned with the at least one opening of the foil assembly,
wherein rotation of the propeller in a first rotational direction is configured to draw a fluid located outside of the shaver head upwardly through the at least one opening of the foil assembly, over the at least one shaver blade and the propeller, and outwardly through the at least one discharge opening of the gear housing cover.

11. The shaver head of claim 10, further comprising:
a gear housing cover coupled to a lower side of a gear housing of the gear housing assembly, the gear housing including the at least one discharge opening, the propeller being rotatably coupled to the gear housing cover; and
at least one containment cylinder including a proximal end attached to the gear housing cover and surrounding the propeller.

12. The shaver head of claim 11, further comprising:
a lower housing arranged between the gear housing cover and the foil assembly and attached to the gear housing cover, the lower housing including at least one opening aligned with the propeller and the at least one shaver blade, the at least one opening including two pivot posts arranged on an inner surface of the at least one opening and spaced apart from each other,
wherein the foil assembly further includes a foil base having an opening that defines the opening of the foil assembly, the foil base further including two pivot tabs extending upwardly from a base portion of the foil base, and wherein the two pivot tabs each include a pivot hole that receives one of the two pivot posts of the lower housing so as to enable pivoting of the foil base relative to the lower housing.

13. The shaver head of claim 11, wherein the at least one containment cylinder further includes at least one discharge port having a terminal end arranged on the at least one discharge opening of the gear housing so as to fluidically connect an interior of the at least one containment cylinder and an environment outside of the gear housing, wherein the at least one shaver blade is aligned with the at least one opening formed in the foil assembly so as to enable the at least one shaver blade to clip hair extending through the at least one opening, and wherein the rotation of the propeller in the first rotational direction draws the fluid upwardly through the at least one opening of the foil assembly, into the containment cylinder, and outwardly through the at least one discharge port such that the fluid flows over the at least one shaver blade and removes hair clippings therefrom and discharges the hair clippings via the at least one discharge port and the at least one discharge opening.

14. The shaver head of claim 10, wherein the shaver head is configured to be cleaned in a cleaning assembly comprising a cleaning and drying container having a grated tray bottom, the cleaning and drying container configured to be positioned in a cleaning base container at a minimal height from a bottom of the cleaning base container, and wherein the fluid is arranged in the cleaning base container such that the shaver head can be at least partially submerged in the fluid so as to allow the rotation of the propeller to draw the fluid upwardly and into the shaver head.

15. The shaver head of claim 10, wherein the shaver head is configured to be attached to a handle, wherein the handle is operable to selectively operate the shaving head in a cleaning mode and in a shaving mode.

16. The shaver head of claim 15, wherein, when the shaving head is operating in the shaving mode, the plurality of propeller blades of the propeller are configured to rotate in a second rotational direction opposite the first rotational direction such that the at least one shaver blade is configured to clip hair extending through the at least one opening of the foil assembly.

17. A method of cleaning a shaver head, comprising:
placing a shaver head in a cleaning assembly comprising a cleaning and drying container having a grated tray bottom, the cleaning and drying container being positioned in a cleaning base container at a minimal height from a bottom of the cleaning base container, wherein the cleaning base container includes a fluid therein, wherein the shaver head includes a gear housing having a shaver blade rotatably arranged therein and a propeller fixedly attached to the shaver blade, the shaver head further including a foil assembly coupled to the gear housing and having an opening aligned with the propeller; and
operating the shaver head in a cleaning mode in which the propeller rotates in a first rotational direction such that the propeller draws the fluid arranged in the cleaning base container upwardly through the opening of the foil assembly.

18. The method of claim 17, wherein the shaver head is configured to operate in a shaving mode in which the propeller is rotated in a second direction opposite to the first direction, and wherein the shaver blade is aligned with the opening of the foil assembly so as to enable the at shaver blade to clip hair extending through the opening.

19. The method of claim 18, wherein the shaver head further comprises at least one containment cylinder including a proximal end attached to the gear housing and surrounding the propeller and the at least one shaver blade.

20. The method of claim 19, wherein the containment cylinder further includes at least one discharge port that opens outwardly from the gear housing so as to fluidically connect an interior of the at least one containment cylinder and an environment outside of the gear housing, and wherein the rotation of the propeller in the first rotational direction draws the fluid upwardly through the opening of the foil assembly, into the at least one containment cylinder, and outwardly through the at least one discharge port such that the fluid flows over the at least one shaver blade and removes hair clippings therefrom.
